(19) United States
(12) Patent Application Publication
(10) Pub. No.: US 2026/0167529 A1
(43) Pub. Date: Jun. 18, 2026

(54) SMART HYDRATION STATION AND METHODS THEREOF

(71) Applicant: Imam Abdulrahman Bin Faisal University, Dammam (SA)

(72) Inventors: Bshayer ALMUTAIRI, Dammam (SA); Noran KATTAN, Dammam (SA); Mai SHUKRI, Dammam (SA); Khadeeja ANSARI, Dammam (SA); Hala EL-WAKEEL, Dammam (SA)

(73) Assignee: Imam Abdulrahman Bin Faisal University, Dammam (SA)

(21) Appl. No.: 18/980,547

(22) Filed: Dec. 13, 2024

(51) Int. Cl. C02F 1/44; C02F 1/32; C02F 1/68; C02F 101/12; C02F 103/02

(52) U.S. Cl. CPC C02F 1/441; C02F 1/32; C02F 1/68; C02F 2101/12; C02F 2103/02; C02F 2201/005; C02F 2209/02

(57) ABSTRACT

A smart hydration station, a method of purifying a feed water thereby, and a method of dispensing filtered water therefrom. The smart hydration station includes a lower section having filtration components including a sediment filter with aluminum sulfate crystal tubes, carbon pre-filter, reverse osmosis unit, carbon post filter, and reverse osmosis tank. A booster pump transfers filtered water to an upper section, which includes ultraviolet lights for sterilization and a hydrogen infusion unit for enriching the water. A middle section includes a tri-temperature water station for dispensing water at selected temperatures through hot, cold, and intermediate water pipes controlled by electronically actuated valves. A microprocessor controls operations including multiple filtration stages, sterilization, hydrogen enrichment, and temperature-controlled delivery. The smart hydration station provides comprehensive water treatment and dispensing capabilities while promoting regular hydration through user engagement features and automated controls.

### BACKGROUND

### Technical Field

The present disclosure is directed to water purification and dispensing systems, and more particularly to smart hydration stations incorporating multiple stages of water treatment, including sediment filtration, carbon filtration, reverse osmosis, ultraviolet sterilization and hydrogen enrichment, along with temperature-controlled dispensing capabilities.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Access to clean, purified drinking water is essential in workplace environments to maintain employee health, wellness and productivity. The growing awareness on impact of water quality on health and productivity has led to increased demand for advanced hydration solutions in workplace environments. Traditional approaches to workplace hydration have relied heavily on bottled water delivery services or basic water dispensers. Bottled water solutions present several challenges including environmental impact from plastic waste, quality inconsistency due to variable storage and transport conditions, and ongoing operational costs associated with regular deliveries and bottle handling. Basic water dispensers typically provide limited functionality, often restricted to simple temperature control options without addressing broader water quality concerns. More advanced water treatment systems have emerged incorporating various purification technologies, but integration of these technologies into comprehensive, user-friendly dispensing stations remains limited.

Additionally, conventional water dispensing systems often focus on basic filtration without addressing the full spectrum of water quality enhancement possibilities. While removal of contaminants through processes like reverse osmosis is important, modern research has highlighted the potential benefits of enhanced water properties, such as hydrogen enrichment. Moreover, existing water dispensing systems typically lack the smart features and user interfaces that have become a requirement in modern workplace equipment. Basic temperature control and simple filtration no longer meet the expectations of health-conscious employees or the operational efficiency requirements of facility managers. Furthermore, the inability to monitor system status, track usage patterns, or receive maintenance alerts leads to inefficient operation and potential disruption of workplace hydration availability.

US20240059542A1 describes a station for dispensing water, specifically alkaline water having a stable pH of between about 8 and about 10. The station includes a display screen configured to display information regarding water properties including pH, temperature, total dissolved solids concentration, and amount dispensed. The station further includes a sediment filter, a pre-carbon filter, a UV filter, and a reverse osmosis chamber. Additionally, the station includes at least one radiofrequency identification (RFID) chip sensor, configured to detect a unique RFID chip in, for example, a bottle of water and automatically update a user profile associated with the unique RFID chip to indicate an amount of water consumed. However, this reference does not address comprehensive water treatment incorporating hydrogen enrichment, nor does it provide the integrated control and user interface features necessary for workplace deployment.

US20210363041A1 describes an apparatus for providing potable water having an inlet, a centrifugal separator, a pre-filter pump, a first filter assembly, another pump, a reverse osmosis filter, a UV sterilizer and a controller, with a display and communications. The apparatus has a temperature transducer at the dispensing end, the controller controls and measures the temperature, and displays information on a touch screen. However, this reference does not address comprehensive water treatment incorporating hydrogen enrichment, nor does it provide the integrated control and user interface features necessary for workplace deployment.

US20220073397A1 describes a water filtration system for producing filtrated drinking water having increased persistence of free hydrogen, pH and ORP level, including a pre-filtration device connected to a water source, a far-infrared filtration device and an elemental hydrogen releasing device. The elemental hydrogen releasing device is configured for utilizing a reaction between elemental magnesium, Mg, or a magnesium mineral and water flowing there through and further configured for releasing free hydrogen and Mg+ ions to water. However, this reference does not address comprehensive water treatment incorporating hydrogen enrichment, nor does it provide the integrated control and user interface features necessary for workplace deployment.

Each of the aforementioned references suffers from one or more drawbacks hindering their adoption, such as failure to combine advanced filtration, sterilization, and smart dispensing capabilities in an integrated solution, and/or incorporate features like hydrogen enrichment, aluminum sulfate crystal filtration, or tri-temperature dispensing with precise electronic control. Accordingly, it is one object of the present disclosure to provide a smart hydration station that combines multiple stages of water treatment with advanced user interface features and automated monitoring capabilities. The present disclosure addresses the limitations of existing systems by incorporating water purification, including sediment filtration, carbon pre and post-filtration, reverse osmosis, UV sterilization, and hydrogen enrichment, while providing precise temperature control and an intuitive user interface for an enhanced hydration experience in workplace environments.

### SUMMARY

In an exemplary embodiment, a smart hydration station is described, comprising a lower section including a feed water intake port configured to connect to a feed water source; a sediment filter connected to the feed water intake port; a carbon pre-filter connected to the sediment filter; a reverse osmosis filtration unit connected to the carbon pre-filter, wherein the reverse osmosis filtration unit is configured to receive a volume of water from the carbon pre-filter and generate filtered water; a carbon post filter connected to the reverse osmosis filtration unit; a reverse osmosis tank connected to carbon post filter; a water pipe having a first end connected to the reverse osmosis tank; a booster pump connected to a second end of the water pipe; a water conveying pipe having a first end connected to the booster pump; an upper section including: a filtered water intake port connected to receive the filtered water from the water conveying pipe; a plurality of ultraviolet lights configured to sterilize the filtered water; a hydrogen infusion unit configured to enrich the sterilized, filtered water with hydrogen; a middle section connected to the hydrogen infusion unit, wherein the middle section includes a tri-temperature water station configured to dispense the hydrogen infused, sterilized, filtered water at a selected temperature; and a microprocessor having electrical circuitry, a memory storing program instructions, and at least one processor configured to execute the program instructions to dispense the hydrogen infused, sterilized, filtered water from the tri-temperature water station at the selected temperature.

In another exemplary embodiment, a method of purifying a feed water by a smart hydration station is described, comprising receiving, through a feed water intake port located in a lower section of the smart hydration station, a feed water from a feed water source; removing, by a sediment filter comprising a plurality of filtration tubes filled with aluminum sulfate crystals, sediment and particulate matter from the feed water; removing, by a carbon pre-filter, odors from the sediment free feed water; filtering, by a reverse osmosis filtration unit connected to the carbon pre-filter, the odor free, sediment free water and generating a quantity of filtered water; post filtering, by a carbon post filter connected to the reverse osmosis filtration unit, chlorine from the quantity of filtered water; receiving, by a reverse osmosis tank connected to carbon post filter, the quantity of chlorine free filtered water; pumping, by a booster pump operatively connected to the reverse osmosis tank, the quantity of chlorine free filtered water into a water reservoir located in an upper section of the smart hydration station; sterilizing, by a plurality of ultraviolet lights, the quantity of chlorine free filtered water; enriching, by a hydrogen infusion unit connected to a plurality of hydrogen intake ports in the water reservoir, the sterilized quantity of chlorine free filtered water with hydrogen gas; receiving, by a microprocessor operatively connected to a touch screen display unit located on an exterior surface of a middle section of the smart hydration station, wherein the microprocessor has electrical circuitry, a memory storing program instructions, and at least one processor configured to execute the program instructions, an input signal based on a selection of a water temperature; and instructing, by the microprocessor, a tri-temperature water station located in the middle section of the smart hydration station to dispense the hydrogen infused, sterilized, chlorine free, filtered water at the selected water temperature.

In yet another exemplary embodiment, a method of dispensing hydrogen infused, sterilized, chlorine free filtered water from a smart hydration station is described, comprising pressing, on a touch screen display unit, an ON button; choosing, from a plurality of selectable input buttons located on the touch screen display unit, one of a hot water input button, a cold water input button and a selectable temperature input button; viewing, on an LED display screen, a set of operational indicators of the smart hydration station which indicate an operational status comprising any one of: a receiving, through a feed water intake port located in a lower section of the smart hydration station, a feed water from a feed water source; a removing, by a sediment filter comprising a plurality of filtration tubes filled with aluminum sulfate crystals, sediment and particulate matter from the feed water; a removing, by a carbon pre-filter, odors from the sediment free feed water; a filtering, by a reverse osmosis filtration unit connected to the carbon pre-filter, the odor free, sediment free water and generating a quantity of filtered water; a post filtering, by a carbon post filter connected to the reverse osmosis filtration unit, chlorine from the quantity of filtered water; a receiving, by a reverse osmosis tank connected to carbon post filter, the quantity of chlorine free filtered water; a pumping, by a booster pump, the chlorine free filtered water from the reverse osmosis tank into a water reservoir, a sterilizing of the chlorine free filtered water in the water reservoir by a plurality of ultraviolet lights, an enriching, by a hydrogen infusion unit, of the sterilized, chlorine free filtered water, a heating, by a heater, of the hydrogen enriched, sterilized, chlorine free filtered water when the hot water input button is pressed, a cooling, by a refrigeration unit, of the hydrogen enriched, sterilized, chlorine free filtered water when the cold water input button is pressed, a mixing, by a two way diverter, of the hydrogen enriched, sterilized, chlorine free filtered water to a selected temperature when the selectable temperature input button, and a dispensing status, by the tri-temperature water station, of the hydrogen enriched, sterilized, chlorine free filtered water.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is an exemplary perspective diagram of a smart hydration station, according to certain embodiments.

FIG. 1B is an exemplary front perspective diagram of the smart hydration station, according to certain embodiments.

FIG. 1C is an exemplary section view of the smart hydration station, according to certain embodiments.

FIG. 1D is an exemplary partial exploded diagram of the smart hydration station, according to certain embodiments.

FIG. 1E is an exemplary illustration of the smart hydration station in partially opened state showing components arranged in a lower section thereof, according to certain embodiments.

FIG. 1F is an exemplary partial illustration of the smart hydration station showing details of an upper section thereof, according to certain embodiments.

FIG. 1G is an exemplary schematic diagram of the smart hydration station, according to certain embodiments.

FIG. 2 is an exemplary exploded diagram of a hydrogen infusion unit of the smart hydration station, according to certain embodiments.

FIG. 3A illustrate an exemplary operational scenario of the smart hydration station generating audio alerts, according to certain embodiments.

FIG. 3B illustrate an exemplary operational scenario of the smart hydration station prompting the user to hydrate, according to certain embodiments.

FIG. 4 is an exemplary flowchart of a method of purifying a feed water by the smart hydration station, according to certain embodiments.

FIG. 5 is an exemplary flowchart of a method of dispensing hydrogen infused, sterilized, chlorine free filtered water from the smart hydration station, according to certain embodiments.

FIG. 6 is an illustration of a non-limiting example of details of computing hardware used in a microcontroller of the smart hydration station, according to certain embodiments.

FIG. 7 is an exemplary schematic diagram of a data processing system used within the microcontroller, according to certain embodiments.

FIG. 8 is an exemplary schematic diagram of a processor used with the microcontroller, according to certain embodiments.

FIG. 9 is an illustration of a non-limiting example of distributed components which may share processing with the computing hardware, according to certain embodiments.

### DETAILED DESCRIPTION

In the drawings, like reference numerals designate identical or corresponding parts throughout the several views. Further, as used herein, the words “a”, “an” and the like generally carry a meaning of “one or more”, unless stated otherwise.

Furthermore, the terms “approximately,” “approximate”, “about” and similar terms generally refer to ranges that include the identified value within a margin of 20%, 10%, or preferably 5%, and any values therebetween.

Aspects of this disclosure are directed to a smart hydration station, a method of purifying feed water by a smart hydration station, and a method of dispensing hydrogen infused, sterilized, chlorine free filtered water from a smart hydration station. The systems and methods of the present disclosure provide comprehensive water purification and dispensing solutions that integrate multiple advanced treatment technologies in a unified, electronically controlled system. The smart hydration station incorporates staged filtration processes, sterilization mechanisms, and water enrichment features, managed through electronic controls and user interface elements. The methods of operation ensure consistent water quality while promoting regular hydration through user engagement features. Unlike conventional water dispensers that typically offer limited purification capabilities or basic temperature control, the present disclosure provides an integrated approach to water processing and dispensing that maintains water purity throughout the treatment cycle while offering precise temperature control and enhanced user interaction. The systems and methods address the limitations of traditional water dispensing solutions by combining multiple treatment technologies with smart monitoring and control features in an ergonomic form factor suitable for workplace environments.

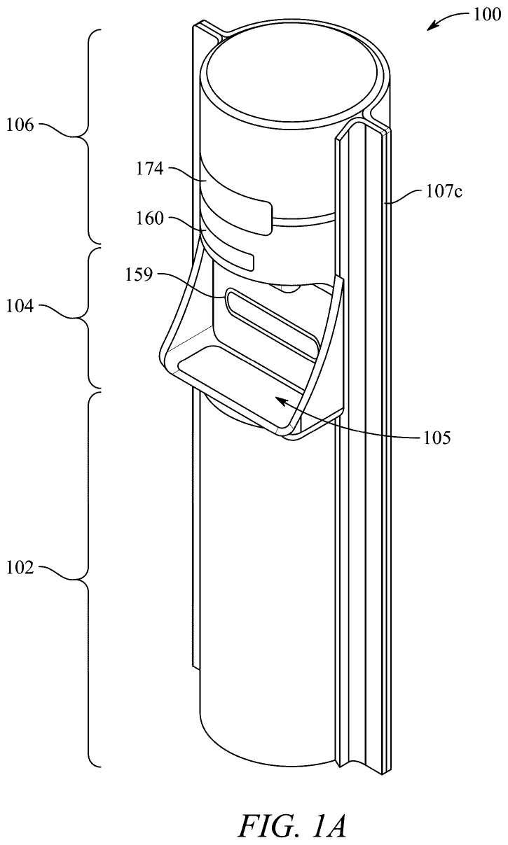

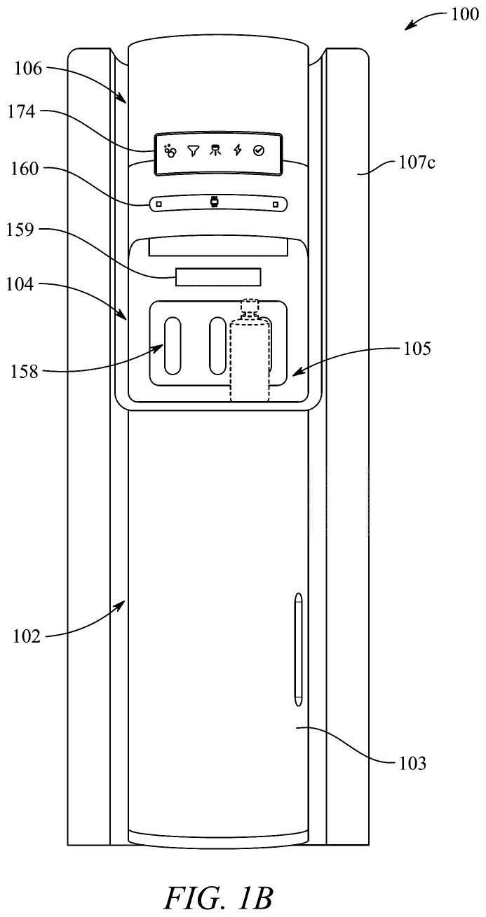

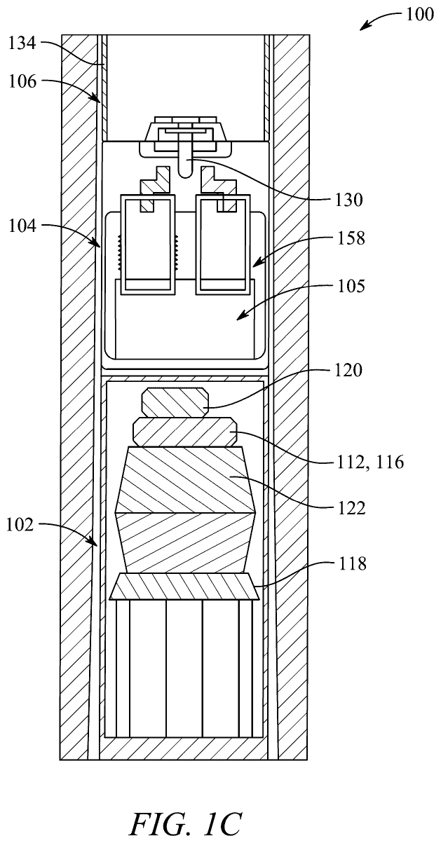

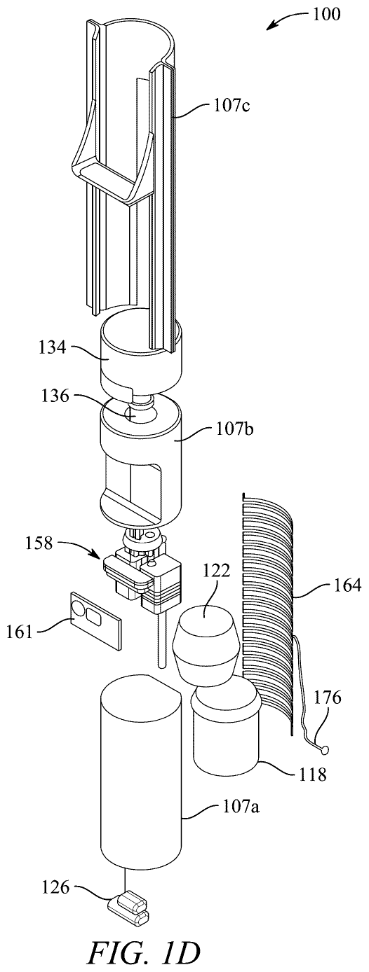

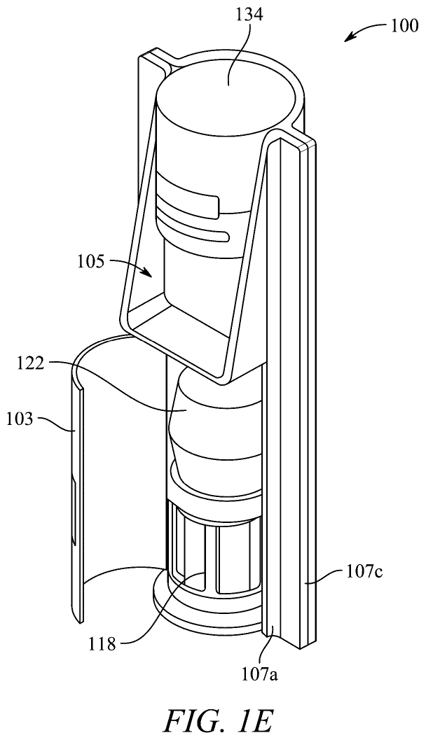

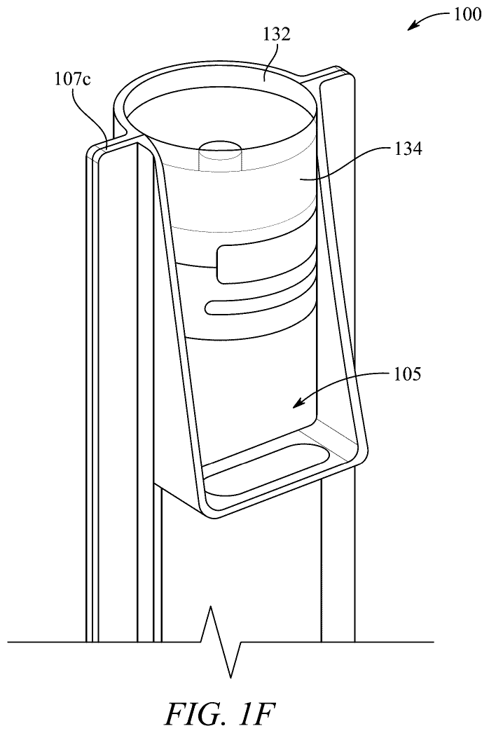

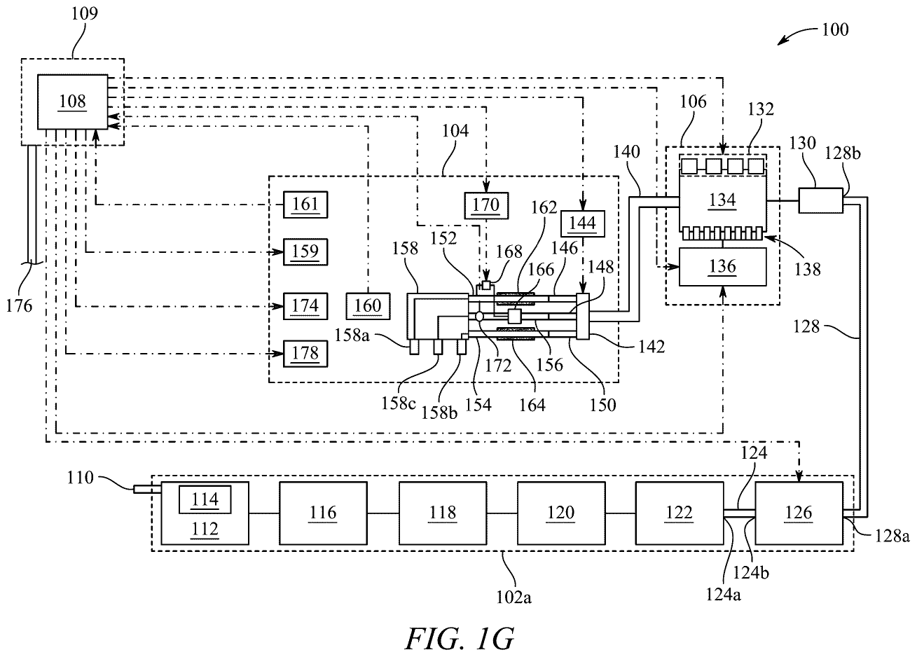

Referring to FIG. 1A to FIG. 1G in combination, illustrated are exemplary diagrams of a smart hydration station (as represented by reference numeral 100). In particular, FIG. 1A is an exemplary perspective diagram of the smart hydration station 100; FIG. 1B is an exemplary front planar diagram of the smart hydration station 100; FIG. 1C is an exemplary section view of the smart hydration station 100; FIG. 1D is an exemplary partial exploded diagram of the smart hydration station 100; FIG. 1E is an exemplary illustration of the smart hydration station in partially opened state; FIG. 1F is an exemplary partial illustration of the smart hydration station; and FIG. 1G is an exemplary schematic diagram of the smart hydration station 100. The smart hydration station 100 is an electronically controlled water processing and dispensing system that integrates multiple water treatment technologies including filtration, sterilization, and hydrogen enrichment capabilities with automated control and user interface features.

The smart hydration station 100 of the present disclosure provides an approach to workplace hydration that combines advanced water treatment technologies with intelligent control systems and user engagement features. The smart hydration station 100, as described herein, integrates multiple stages of water processing, including filtration, sterilization, and enrichment/enhancement, while incorporating advanced electronic controls and monitoring systems. This integration of technologies, combined with an emphasis on user interaction and engagement, provides a comprehensive hydration solution particularly suited for workplace environments such as office buildings, healthcare facilities, educational institutions, and industrial settings. It may be appreciated that although the present disclosure describes application of the smart hydration station 100 in a workplace environment, the smart hydration station 100 may be applicable in various other environments including but not limited to residential buildings, shopping centers, transportation hubs, sports facilities, convention centers, hotels, restaurants, medical facilities, schools, universities, government buildings, and other public or private spaces where controlled dispensing of purified, temperature-regulated water is desired.

As illustrated, the smart hydration station 100 has multiple sections for processing and dispensing water. In the present configuration, the smart hydration station 100 includes a lower section 102, a middle section 104, and an upper section 106. As better shown in FIGS. 1D and 1E, the smart hydration station 100 has a lower body cover 107a which covers the lower section 102. In an example, the lower body cover 107a may be made of a translucent material. In some examples, the lower section 102 may also be provided with a door 103, supported on the lower body cover 107a, to facilitate access to components inside thereof, such as for maintenance purposes. The smart hydration station 100 also has a middle body cover 107b which covers the middle section 104. In an example, the middle body cover 107b may be made of matte and smooth material. The smart hydration station 100 further has a main body cover 107c which provides a base structure to support various components therein, including the back sides of the lower section 102, the middle section 104 and the upper section 106. In an example, the main body cover 107c may be made of frosted translucent material to give feeling of cleanliness.

In the smart hydration station 100, the lower section 102 includes the primary water intake and initial treatment components, for the water processing operations. The lower section 102 incorporates multiple filtration stages and water storage mechanisms, processing the feed water through a sequence of treatment steps before forwarding the processed water to subsequent sections. The middle section 104 serves as the primary user interface zone where water dispensing operations occur, incorporating temperature control mechanisms and dispensing ports positioned at ergonomic heights suitable for workplace environments. The middle section 104 includes a dispensing area 105 with electronic controls designed to minimize physical contact while maintaining precise control over water temperature and flow. The upper section 106 includes advanced water treatment and enhancement technologies, receiving pre-filtered water from the lower section 102 and implementing additional purification and enhancement processes before the water reaches the dispensing mechanisms in the middle section 104. The upper section 106 connects to the middle section 104 through a controlled flow path that ensures maintenance of water quality throughout the dispensing process.

In an example, the smart hydration station 100 has an overall height of about 167 cm from a lower surface of the lower section 102 to an upper surface of the upper section 106, a width of about 38 cm, and a depth of about 38 cm. These dimensions are selected to provide an ergonomic and space-efficient design suitable for workplace environments while maintaining sufficient internal volume for housing the water processing components. The three sections 102, 104, 106 of the smart hydration station 100 are designed with specific dimensional relationships to achieve optimal functionality in workplace settings. Each section 102-106 is proportioned to accommodate internal components while maintaining a space-efficient external profile appropriate for installation in office buildings, industrial facilities, healthcare institutions, educational campuses, and the like. The sections 102-106 are arranged to facilitate efficient water flow patterns while providing access for maintenance and servicing of internal components. The modular design of the sections 102-106 facilitates easy assembly and maintenance procedures while ensuring proper isolation between different treatment stages and temperature zones within the smart hydration station 100.

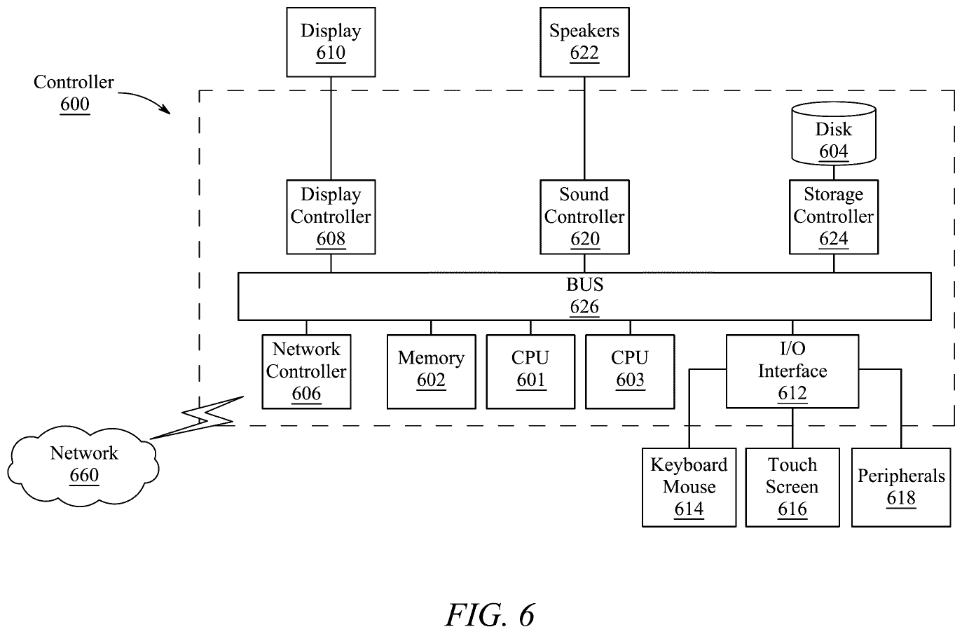

The smart hydration station 100 includes a microprocessor 108 which may be positioned within an electronics housing 109 (as schematically shown in FIG. 1G). It may be appreciated that the microprocessor 108 with the electronics housing 109 may be located in any one of the three sections 102, 104, 106 of the smart hydration station 100. The microprocessor 108 includes electrical circuitry, a memory storing program instructions, and at least one processor configured to execute the program instructions to control operations of the smart hydration station 100. The microprocessor 108 represents a computational system that may be embodied in a variety of forms including microcontrollers, digital signal processors, field programmable gate arrays, application-specific integrated circuits, or combinations thereof. The electrical circuitry of the microprocessor 108 may include analog and digital components configured to process signals from sensors and control various electromechanical components of the smart hydration station 100. The memory of the microprocessor 108 may include volatile and non-volatile storage elements configured to store program instructions and operational data. The at least one processor of the microprocessor 108 may include single or multiple processing cores configured to execute instructions for controlling the smart hydration station 100 in real-time. Further details about the microprocessor 108 are discussed later in detail in reference to FIGS. 6-9.

In the smart hydration station 100, as schematically illustrated in FIG. 1G, the lower section 102 includes a feed water intake port 110 configured to connect to a feed water source (not shown). Herein, the feed water source may be any water source such as tap water or some other water supply available in the workplace environment. The feed water intake port is positioned at a lower portion of the lower section 102 and establish a secure connection with the feed water source, which is generally located externally, to receive feed water for processing. The feed water intake port 110 may include standardized connection fittings compatible with common workplace plumbing systems. In an example, the feed water intake port 110 may incorporate a pressure regulator to maintain optimal input pressure for subsequent filtration processes, and a shutoff valve to provide isolation of the smart hydration station 100 from the feed water source during maintenance operations.

The lower section 102 also includes a sediment filter 112 connected to the feed water intake port 110. The sediment filter 112 serves as the initial filtration stage for removing particulate matter and suspended solids from the feed water. The sediment filter 112 may be connected to the feed water intake port 110 through a water-tight connection pathway. The sediment filter 112 is positioned vertically within the lower section 102 to optimize gravitational flow for filtration purposes and facilitate easy access for maintenance. In an aspect of the present disclosure, the sediment filter 112 includes a plurality of filtration tubes 114 (schematically shown in FIG. 1G) filled with aluminum sulfate crystals. The plurality of filtration tubes 114 may be arranged in a parallel configuration within a filter housing or the like. Each filtration tube 114 is filled with the aluminum sulfate crystals (not visible) specifically selected for their superior particle removal capabilities. The aluminum sulfate crystals are arranged within the filtration tubes 114 to maximize contact surface area while maintaining consistent flow rates through the sediment filter 112. The aluminum sulfate crystals effectively remove suspended particles, sediment, and turbidity from the feed water through both mechanical filtration and chemical coagulation processes.

The lower section 102 further includes a carbon pre-filter 116 connected to the sediment filter 112. The carbon pre-filter 116 may be connected to the sediment filter 112 through a sealed connection channel. The carbon pre-filter 116 may be positioned vertically within the lower section 102, downstream of the sediment filter 112. The carbon pre-filter 116 includes activated carbon media specifically selected for removal of chlorine, organic compounds, and chemical contaminants from the water. In an example configuration, the carbon pre-filter 116 may incorporate a filter cartridge housing designed for easy replacement during maintenance operations. The activated carbon media may be configured in a gradient density arrangement to increase contact time and thereby filtration efficiency, while maintaining consistent flow rates through the carbon pre-filter 116.

The lower section 102 further includes a reverse osmosis filtration unit 118 connected to the carbon pre-filter 116. The reverse osmosis filtration unit 118 may be connected to the carbon pre-filter 116 through a high-pressure connection assembly. The reverse osmosis filtration unit 118, generally, includes a semi-permeable membrane configured to remove dissolved solids and impurities from the water. The semi-permeable membrane is specifically selected to achieve required rejection rates of dissolved solids while maintaining appropriate flow rates for the smart hydration station 100. The reverse osmosis filtration unit 118 is configured to receive a volume of water from the carbon pre-filter 116 and generate filtered water. Specifically, the reverse osmosis filtration unit 118 receives the volume of pre-filtered water from the carbon pre-filter 116 and generate filtered water meeting specific purity standards. In an example configuration, the reverse osmosis filtration unit 118 incorporates a membrane housing, a concentrated water outlet, and a filtered water outlet, to support the filtering process. Further, the reverse osmosis filtration unit 118 operates under precisely controlled pressure conditions, which may be maintained by a pressure regulation system.

The lower section 102 further includes a carbon post filter 120 connected to the reverse osmosis filtration unit 118. The carbon post filter 120 may be connected to the reverse osmosis filtration unit 118 through a sealed water pathway. In an example configuration, the carbon post filter 120 includes a specialized activated carbon blend housed within a filter cartridge. The carbon post filter 120 is positioned to provide sufficient contact time between the filtered water and the activated carbon blend while maintaining appropriate system pressure and flow rates. The carbon post filter 120 serves as a final polishing stage to remove any remaining trace contaminants and improve the taste of the filtered water. In some examples, the carbon post filter 120 may also incorporate a filter monitoring sensor that connects to the microprocessor 108 to track filter life and performance.

The lower section 102 further includes a reverse osmosis tank 122 connected to the carbon post filter 120. The reverse osmosis tank 122 is positioned within the lower section 102 for better space utilization while maintaining accessibility for maintenance operations. The filtered water from the reverse osmosis filtration unit 118 passes through the carbon post filter 120 for final polishing before being stored in the reverse osmosis tank 122. The reverse osmosis tank 122 may be connected to the carbon post filter 120 through a sealed connection fitting. The reverse osmosis tank 122 is configured to store the filtered water processed through the previous filtration stages. In an example configuration, the reverse osmosis tank 122 includes a food-grade butyl rubber bladder that expands and contracts to accommodate varying water volumes while maintaining system pressure. The reverse osmosis tank 122 may also incorporate a float sensor that monitors water level and communicates with the microprocessor 108 to control the filtration process.

Further, as illustrated in FIGS. 1A-1G in combination, the lower section 102 includes a water pipe 124 having a first end 124a connected to the reverse osmosis tank 122. The water pipe 124 may be connected to the reverse osmosis tank 122 through a watertight connection assembly or the like to maintain system integrity and prevent leakage. The water pipe 124 is configured to transport the filtered water from the reverse osmosis tank 122 to subsequent processing stages. In some examples, the water pipe 124 may include monitoring sensors (not shown) to detect pressure and flow rates therethrough, which may be communicated to the microprocessor 108 to control the filtration process.

The lower section 102 further includes a booster pump 126 connected to a second end 124b of the water pipe 124. The booster pump 126 is positioned in the lower section 102 to regulate flow of water (as being processed) in the smart hydration station 100. The booster pump 126 may be connected to the water pipe 124 through a secure mounting bracket and sealed fittings. The booster pump 126 is specifically sized to maintain optimal water pressure throughout the smart hydration station 100, typically operating at a pressure range of 40-60 psi. In an example configuration, the booster pump 126 may incorporates pressure sensors and electronic controls that communicate with the microprocessor 108 to regulate its operation based on system demands.

The lower section 102 further includes a water conveying pipe 128 having a first end 128a connected to the booster pump 126. The water conveying pipe 128 may be connected to the booster pump 126 through high-pressure fittings designed to maintain system integrity. The water conveying pipe 128 is configured to transport pressurized filtered water from the booster pump 126 to the upper section 106 of the smart hydration station 100. In an example configuration, the water conveying pipe 128 may incorporate flow monitoring sensors (not shown) to ensure proper water distribution in the smart hydration station 100. The water conveying pipe 128 is routed through the lower section 102 in a manner that facilitates easy access for maintenance while maintaining efficient space utilization.

Still referring to FIGS. 1A-1G in combination, in the smart hydration station 100, the upper section 106 includes a filtered water intake port 130 connected to receive the filtered water from the water conveying pipe 128. The filtered water intake port 130 may be positioned at a lower portion of the upper section 106 to establish a secure connection with a second end 128b of the water conveying pipe 128. The filtered water intake port 130 may be connected to the water conveying pipe 128 through a sealed connection assembly designed to prevent any leakage or contamination. The filtered water intake port 130 is configured to receive the pressurized filtered water from the lower section 102 and direct it to subsequent treatment stages within the upper section 106. In an example configuration, the filtered water intake port 130 may incorporate pressure monitoring sensors that communicate with the microprocessor 108 to ensure proper water flow and pressure levels are maintained during operation.

The upper section 106 further includes a plurality of ultraviolet lights 132 configured to sterilize the filtered water received through the filtered water intake port 130. The plurality of ultraviolet lights 132 are strategically positioned within the upper section 106 to provide comprehensive UV exposure to the filtered water. In some examples, the plurality of ultraviolet lights 132 may be housed within protective quartz sleeves (not shown) that facilitate UV transmission while protecting the lights from water contact. In an example configuration, the plurality of ultraviolet lights 132 include four UV-C lights rated at 254 nanometers wavelength, arranged to ensure uniform sterilization coverage of the water being processed. Each of the plurality of ultraviolet lights 132 may be monitored by UV intensity sensors (not shown) that provide feedback to the microprocessor 108 to ensure proper sterilization levels are maintained. The plurality of ultraviolet lights 132 are configured to operate continuously during system operation, with built-in monitoring systems to detect any malfunction or decrease in sterilization efficiency.

UV-C light has the shortest wavelength and is known for its germicidal properties. This short wavelength makes UV-C effective at destroying the genetic material in viruses and bacteria, including SARS-COV-2, the virus responsible for COVID-19.

In aspects of the present disclosure, the upper section 106 includes a water reservoir 134 connected to the filtered water intake port 130. The water reservoir 134 is positioned within the upper section 106 to receive and hold the filtered water for additional treatment processes. For present purposes, the water reservoir 134 may be constructed of food-grade materials and includes a double-wall configuration for improved temperature stability. In an example configuration, the water reservoir 134 incorporates level sensors (not shown) that communicate with the microprocessor 108 to maintain optimal water levels. The water reservoir 134 may also include baffles or other flow-directing structures to ensure proper water circulation and treatment exposure. The water reservoir 134 is sized to maintain sufficient water volume for consistent operation while optimizing the space utilization within the upper section 106.

The upper section 106 further includes at least one ultraviolet light 132 located at least partially within the water reservoir 134. The at least one ultraviolet light 132, for example, a UV-C light, is positioned to provide direct sterilization of the filtered water held within the water reservoir 134. The at least one ultraviolet light 132 may be housed within the protective quartz sleeve that extends into the water reservoir 134, facilitating UV transmission while protecting the light assembly from water contact. The positioning and arrangement of the at least one ultraviolet light 132 within the water reservoir 134 is specifically designed to achieve uniform UV exposure throughout the stored water volume.

The upper section 106 further includes a hydrogen infusion unit 136 configured to enrich the sterilized, filtered water with hydrogen. The hydrogen infusion unit 136 is positioned within the upper section 106 to process water after UV sterilization. The hydrogen infusion unit 136 operates through a controlled electrolysis process to generate and infuse hydrogen into the sterilized, filtered water within the water reservoir 134.

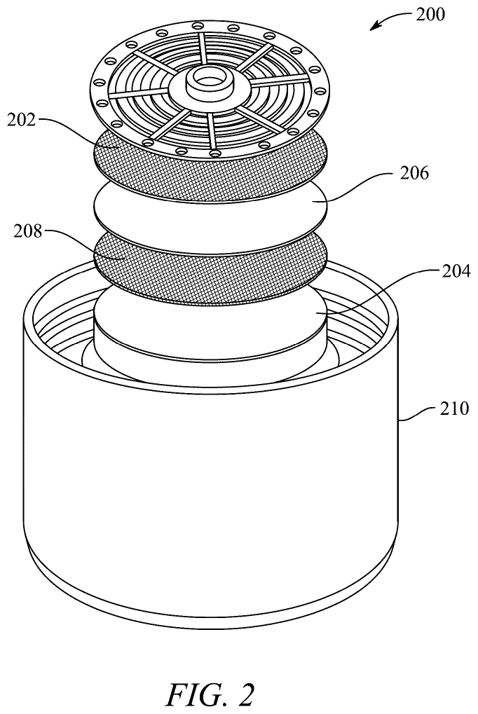

FIG. 2 illustrates an exemplary exploded diagram of the hydrogen infusion unit 136 (referred to as 200 in FIG. 2) of the smart hydration station 100. The hydrogen infusion unit 136 provides an electrolyzer cell including an upper cathode platinum electrolytic sheet 202 and a lower cathode platinum electrolytic sheet 204, both configured for hydrogen generation through electrolysis. The hydrogen infusion unit 136 further includes a cation exchange membrane 206 and an anode platinum electrolytic sheet 208 arranged between the cathode platinum electrolytic sheets 202, 204. Herein, the anode platinum electrolytic sheet 208 and the cathode platinum electrolytic sheets 202, 204 are positioned in a stacked configuration, separated by the cation exchange membrane 206. The cation exchange membrane 206 incorporates a proton exchange material specifically selected for optimal hydrogen ion transfer during the electrolysis process. In some examples, the hydrogen infusion unit 136 may also incorporate a dissolved hydrogen sensor (not shown) that continuously monitors the concentration of hydrogen in the water, typically maintaining levels between 0.8 and 1.2 parts per million (ppm) for present purposes. The hydrogen infusion unit 200 houses these components within a cylindrical casing 210. The stacked arrangement of components within the hydrogen infusion unit 200 facilitates efficient electrolysis of water to generate hydrogen gas, which is then directed for infusion into the filtered, sterilized water.

Referring back to FIGS. 1A-1G in combination, the upper section 106 further includes a plurality of hydrogen intake ports 138 located on the water reservoir 134. The plurality of hydrogen intake ports 138 are configured to receive a hydrogen gas from the hydrogen infusion unit 136. Herein, the plurality of hydrogen intake ports 138 may receive the hydrogen gas generated by the hydrogen infusion unit 136 through gas transfer lines. The plurality of hydrogen intake ports 138 may be positioned around the water reservoir 134 to achieve uniform hydrogen distribution throughout the water volume. In an example configuration, each of the plurality of hydrogen intake ports 138 incorporates micro-bubble diffusers that create fine hydrogen bubbles for optimal dissolution into the water. Further, the plurality of hydrogen intake ports 138 may incorporate pressure regulation mechanisms to maintain consistent hydrogen flow rates. The arrangement and design of the plurality of hydrogen intake ports 138 provides hydrogen infusion while preventing any gas leakage or pressure buildup within the water reservoir 134. In the smart hydration station 100, the plurality of hydrogen intake ports 138 operate in coordination with the hydrogen infusion unit 136, with their operation controlled by the microprocessor 108 based on real-time dissolved hydrogen measurements.

In particular, during operation of the smart hydration station 100, the electrolyzer cell of the hydrogen infusion unit 136 receives a regulated electrical current causing electrolysis of a small portion of the filtered water to generate pure hydrogen gas. The generated hydrogen gas is directed through gas transfer lines to the plurality of hydrogen intake ports 138. The micro-bubble diffusers at each of the plurality of hydrogen intake ports 138 break down the hydrogen gas into microscopic bubbles, maximizing dissolution into the water. The dissolved hydrogen sensor continuously monitors hydrogen concentration levels in the water, providing feedback to the microprocessor 108. Based on these measurements, the microprocessor 108 adjusts the power supply to the electrolyzer cell to maintain the hydrogen concentration between 0.8 and 1.2 parts per million. The pressure regulation mechanisms at the plurality of hydrogen intake ports 138 ensure consistent hydrogen flow rates while preventing backflow of water into the hydrogen infusion unit 136. The operation of the hydrogen infusion unit 136 is synchronized with the water flow rates and treatment processes to maintain consistent hydrogen enrichment levels in the water being dispensed from the smart hydration station 100.

Still referring to FIGS. 1A-1G in combination, in the smart hydration station 100, the middle section 104 is positioned between the upper section 106 and the lower section 102 and is connected to the hydrogen infusion unit 136 to receive the hydrogen infused, sterilized, filtered water for dispensing. As illustrated in FIG. 1G, the middle section 104 includes a water receiving pipe 140 connected to the water reservoir 134. The water receiving pipe 140 is positioned to establish a flow path from the upper section 106 to the dispensing mechanisms in the middle section 104. Herein, the water receiving pipe 140 is configured to receive the filtered, sterilized, hydrogen infused water from the water reservoir 134. The middle section 104 includes a three-way diverter 142 connected to the water receiving pipe 140. The three-way diverter 142 includes a first electronically actuated valve 144 for controlled water flow distribution. The first electronically actuated valve 144 is configured to direct the filtered, sterilized, hydrogen infused water into at least one of a first output port 146, a second output port 148, and a third output port 150. The first electronically actuated valve 144 operates under control of the microprocessor 108, which determines the appropriate output port based on user temperature selection.

In the present configuration, the middle section 104 includes a hot water dispensing pipe 152 connected to the first output port 146 of the three-way diverter 142. The hot water dispensing pipe 152 is configured with heat-resistant materials suitable for conveying heated water. The middle section 104 further includes a cold water dispensing pipe 154 connected to the second output port 148 of the three-way diverter 142. The cold water dispensing pipe 154 may include insulation to maintain the desired cold water temperature during dispensing operations. The middle section 104 further includes an intermediate pipe 156 connected to the third output port 150 of the three-way diverter 142. The intermediate pipe 156 is configured to receive water for dispensing at user-selected intermediate temperatures.

The middle section 104 includes a tri-temperature water station 158 configured to dispense the hydrogen infused, sterilized, filtered water at a selected temperature. The tri-temperature water station 158 connects to each of the hot water dispensing pipe 152, the cold water dispensing pipe 154, and the intermediate pipe 156. The tri-temperature water station 158 may incorporate temperature sensors (not shown) at various points to monitor and maintain precise temperature control of the water being dispensed. In an example configuration, the tri-temperature water station 158 includes separate dispensing ports (discussed later) for hot, cold, and temperature-controlled water delivery. The tri-temperature water station 158 connects to the microprocessor 108 through control interfaces that regulate water flow, temperature adjustment, and dispensing operations based on user inputs and system parameters.

In an example configuration, the smart hydration station 100 has a height from the lower surface of the lower section to a lower surface of the tri-temperature water station 158 of about 90.5 cm. That is, the tri-temperature water station 158 is positioned at a height of approximately 90.5 centimeters, which represents an ergonomic dispensing height to provide comfortable access for users of varying heights.

In some aspects of the present disclosure, the tri-temperature water station 158 incorporates a temperature indication display 159 positioned above the dispensing area 105 (as illustrated in FIGS. 1A and 1B). The temperature indication display 159 includes a translucent panel with a graduated color gradient ranging from blue to red, representing cold to hot temperatures respectively. The temperature indication display 159 includes an internal LED array configured to illuminate specific sections of the translucent panel based on the current dispensing temperature. The LED array is controlled by the microprocessor 108 to move the illuminated portion along the color gradient in real-time as the dispensing temperature changes. In an example configuration, the temperature indication display 159 may display blue illumination when dispensing cold water at or below approximately 10° C., red illumination when dispensing hot water at or above approximately 75° C., and intermediate colors corresponding to selected temperatures between these ranges. The temperature indication display 159 provides visual feedback to users regarding the current dispensing temperature through this illuminated color gradient system.

The middle section 104 further includes a touch screen display unit 160 located on an exterior surface thereof. The touch screen display unit 160 may be positioned above the tri-temperature water station 158 for easy access and visibility. The touch screen display unit 160 incorporates a capacitive touch panel with an anti-glare coating for improved visibility in various lighting conditions. The touch screen display unit 160 is configured with selectable input buttons comprising an ON button, an OFF button, a hot water input button, a cold water input button and a selectable temperature input button. Each selectable input button is presented on the touch screen display unit 160 with distinctive icons and clear labeling for intuitive operation. The microprocessor 108 is operatively connected to the touch screen display unit 160 and is configured to receive signals based on a selection of an input button. In some examples, the touch screen display unit 160 may also be configured to display real-time temperature readings and operational status indicators corresponding to the selected dispensing mode.

In some examples, the tri-temperature water station 158 incorporates a proximity sensor 161 (as also shown in FIG. 1D) configured to detect presence of objects, such as water bottles or containers, in the dispensing area 105. The proximity sensor 161 may be in the form of an ultrasonic sensor that emits high-frequency sound waves and detects their reflection from objects within the dispensing zone. The proximity sensor 161 connects to the microprocessor 108 to provide real-time detection signals. When the proximity sensor 161 detects a container in the dispensing area 105, the proximity sensor 161 sends a signal to the microprocessor 108, which then enables the dispensing operation based on the temperature selection made through the touch screen display unit 160. In an example configuration, the proximity sensor 161 may be calibrated to detect objects within a specific distance range, typically 5-15 centimeters from the dispensing nozzles 158a, 158b, 158c, to prevent accidental dispensing. The proximity sensor 161 may also incorporate multiple sensing zones to ensure accurate container placement beneath the appropriate dispensing nozzle. The microprocessor 108 may be programmed to require both proximity detection by the proximity sensor 161 and user input through the touch screen display unit 160 before initiating water dispensing, thereby preventing accidental dispensing and potential spillage.

In aspects of the present disclosure, the microprocessor 108 is configured to actuate the first electronically actuated valve 144 to divert the hydrogen infused, sterilized, filtered water to the hot water dispensing pipe 152 when the hot water input button is selected. Upon receiving a signal indicating hot water selection on the touch screen display unit 160, the microprocessor 108 sends control signals to activate the first electronically actuated valve 144. As illustrated in FIG. 1G, the smart hydration station 100 includes a heating element 162 surrounding a portion of the hot water dispensing pipe 152. The heating element 162 is controlled by the microprocessor 108. The heating element 162 may incorporate resistance heating coils configured to heat the hydrogen infused, sterilized, filtered water to a pre-set hot water temperature when the hot water input button is selected. In an example configuration, the heating element 162 maintains the water temperature between 85° C. and 95° C. Herein, the tri-temperature water station 158 includes a hot water dispensing nozzle 158a connected to the hot water dispensing pipe 152. The hot water dispensing nozzle 158a is configured to dispense the heated hydrogen infused, sterilized, filtered water in a controlled manner.

The microprocessor 108 is further configured to actuate the first electronically actuated valve 144 to divert the hydrogen infused, sterilized, filtered water to the cold water dispensing pipe 154 when the cold water input button is selected. Upon receiving a signal indicating cold water selection on the touch screen display unit 160, the microprocessor 108 sends control signals to activate the first electronically actuated valve 144. The smart hydration station 100 includes a refrigeration unit 164 connected to the cold water dispensing pipe 154. The refrigeration unit 164 is controlled by the microprocessor 108. The refrigeration unit 164 may incorporate a compressor and cooling coils configured to cool the hydrogen infused, sterilized, filtered water to a pre-set cold water temperature when the cold water input button is selected. In an example configuration, the refrigeration unit 164 maintains the water temperature between 4° C. and 10° C. Herein, the tri-temperature water station 158 includes a cold water output port 158b connected to the cold water dispensing pipe 154. The cold water output port 158b is configured to dispense the cooled hydrogen infused, sterilized, filtered water in a controlled manner.

In an aspect, the smart hydration station 100 further includes a coupler 166 connected to the intermediate pipe 156. The coupler 166 may be connected to the intermediate pipe 156 through sealed connection fittings to maintain system integrity. The smart hydration station 100 further includes a two way diverter 168 configured to connect to the coupler 166 and to the hot water dispensing pipe 152. The two way diverter 168 includes a second electronically actuatable valve 170 controlled by the microprocessor 108. The smart hydration station 100 includes a temperature sensor 172 located on the intermediate pipe 156 downstream of the coupler 166. The temperature sensor 172 is configured to provide real-time temperature measurements to the microprocessor 108. The microprocessor 108 is configured to receive a temperature reading from the temperature sensor 172 and a selected temperature from the selectable temperature input button on the touch screen display unit 160. Based on these inputs, the microprocessor 108 is configured to actuate the second electronically actuatable valve 170 to divert hot water from the hot water dispensing pipe 152 to the intermediate pipe 156 until the temperature reading matches the selected temperature. The microprocessor 108 continuously monitors readings from the temperature sensor 172 and adjusts the second electronically actuatable valve 170 to maintain the desired temperature. Herein, the tri-temperature water station 158 includes a selectable temperature dispensing nozzle 158c connected to the intermediate pipe 156 downstream of the coupler 166. The selectable temperature dispensing nozzle 158c is configured to dispense the hydrogen infused, sterilized, filtered water at the selected temperature. In an example configuration, the selectable temperature dispensing nozzle 158c may incorporate flow control features to ensure smooth and consistent water flow at the selected temperature.

Referring again to FIGS. 1A-1G in combination, the smart hydration station 100 further includes an LED display screen 174 configured to display a set of operational indicators of the smart hydration station 100. The LED display screen 174 is positioned above the touch screen display unit 160 for clear visibility. The LED display screen 174 may be configured to display various operational parameters including power status, water temperature, filtration status, UV sterilization status, a self-cleaning cycle and the hydrogen infusion process, as shown in FIG. 1B. The LED display screen 174 receives display signals from the microprocessor 108 to update the operational indicators in real-time. The smart hydration station 100 also includes a power cord 176 configured to connect to a power source (not shown). The power cord 176 may incorporate overcurrent protection mechanisms and electromagnetic interference suppression features. The power cord 176 is configured to provide electrical power to all electrical and electronic components of the smart hydration station 100 through appropriate power distribution circuitry.

The smart hydration station 100 further includes the electronics housing 109 (as discussed) located behind the touch screen display unit 160. The electronics housing 109 is configured to protect electronic components from environmental factors and provide electromagnetic shielding. The microprocessor 108 is located within the electronics housing 109 and is operatively connected to the power cord 176, the booster pump 126, the ultraviolet lights 132, the hydrogen infusion unit 136, and the LED display screen 174 through appropriate control and data interfaces. The electronics housing 109 may incorporate cooling features to maintain optimal operating temperatures for the electronic components. The at least one processor of the microprocessor 108 is configured to execute the program instructions when an ON input is received on the touch screen display unit 160, initiating system startup and operational control sequences.

As discussed, in the smart hydration station 100, the LED display screen 174 is configured to display the set of operational indicators. In an aspect of the present disclosure, the set of operational indicators include an ON indicator, an OFF indicator, a READY indicator, and a process bar. The ON indicator illuminates when the smart hydration station 100 is powered and operational, while the OFF indicator illuminates when the smart hydration station 100 is powered off or in standby mode. The READY indicator activates when the smart hydration station 100 is prepared to dispense water at the selected temperature. The process bar is configured to display a status of a progress of the hydrogen infused, sterilized, filtered water from the lower section 102 through the upper section 106 to the middle section 104. In an example configuration, the process bar includes multiple LED segments that illuminate sequentially to indicate water progression through various treatment stages. The process bar may display different stages including initial filtration in the lower section 102, UV sterilization and hydrogen infusion in the upper section 106, and temperature adjustment in the middle section 104. The process bar provides real-time visual feedback as water moves through the smart hydration station 100, updating in response to signals from various sensors monitored by the microprocessor 108. The microprocessor 108 controls the illumination patterns and timing of all indicators on the LED display screen 174 based on actual system operations and sensor readings throughout the water processing cycle.

In an example configuration, the LED display screen 174 may incorporate multiple icon-based indicators representing different operational states including tank filling status, UV sterilization status, and hydrogen infusion status. Each icon-based indicator on the LED display screen 174 may be illuminated or animated to show active processing states. For example, when tanks are filling, a corresponding tank icon illuminates; when UV sterilization is active, a UV lamp icon becomes highlighted; and when hydrogen infusion is in process, a hydrogen bubble icon activates. The LED display screen 174 connects to the microprocessor 108 to receive real-time status updates from various components and sensors throughout the smart hydration station 100. In an example configuration, the LED display screen 174 may also incorporate check mark indicators that illuminate upon successful completion of each processing stage, providing users with clear visual confirmation of proper system operation.

In general, the microprocessor 108 is configured to execute the program instructions to dispense the hydrogen infused, sterilized, filtered water from the tri-temperature water station 158 at the selected temperature. The microprocessor 108 receives input signals from various sensors throughout the smart hydration station 100, including temperature sensors, pressure sensors, flow sensors, UV intensity sensors, and hydrogen concentration sensors. Based on these inputs, the microprocessor 108 controls multiple operational aspects including water flow rates, filtration processes, UV sterilization, hydrogen infusion, and temperature adjustment. The microprocessor 108 also regulates the operation of the heating element 162 and the refrigeration unit 164 along with the tri-temperature water station 158 to maintain precise temperature control of the dispensed water. The microprocessor further manages the LED display screen 174 to provide real-time feedback about system operation. The microprocessor 108 may further execute program instructions to perform system diagnostics, monitor component performance, track maintenance requirements, and implement safety protocols during operation of the smart hydration station 100.

In some aspects of the present disclosure, the smart hydration station 100 includes a speaker 178 operatively connected to the microprocessor 108. The speaker 178 may be positioned within the middle section 104 and connects to the microprocessor 108 through audio control circuitry. The microprocessor 108 is configured to generate an alert through the speaker 178 when the hydrogen infused, sterilized, filtered water at the selected temperature is ready to be dispensed. In an example configuration, the alert may include pre-programmed audio patterns such as a single beep, multiple beeps in a defined sequence, or voice messages indicating water availability. The speaker 178 may generate alerts at different volumes based on the ambient noise levels or user preferences programmed through the touch screen display unit 160.

The microprocessor 108 is further configured to generate a periodic reminder to drink the hydrogen infused, sterilized, filtered water. The microprocessor 108 generates the periodic reminder through the speaker 178 to encourage regular consumption of the hydrogen infused, sterilized, filtered water. The periodic reminder may be programmed with customizable time intervals ranging from 30 minutes to 2 hours during designated operational hours, typically aligned with standard workplace schedules (e.g., 9:00 AM to 5:00 PM). In an example, the microprocessor 108 may adjust reminder timing based on usage patterns or pre-set schedules stored in its memory. The reminder function may be enabled or disabled through the touch screen display unit 160, for users to customize the hydration reminder system according to workplace preferences. The periodic reminders may include varying audio patterns or voice messages to maintain user engagement and promote regular hydration habits in the workplace environment.

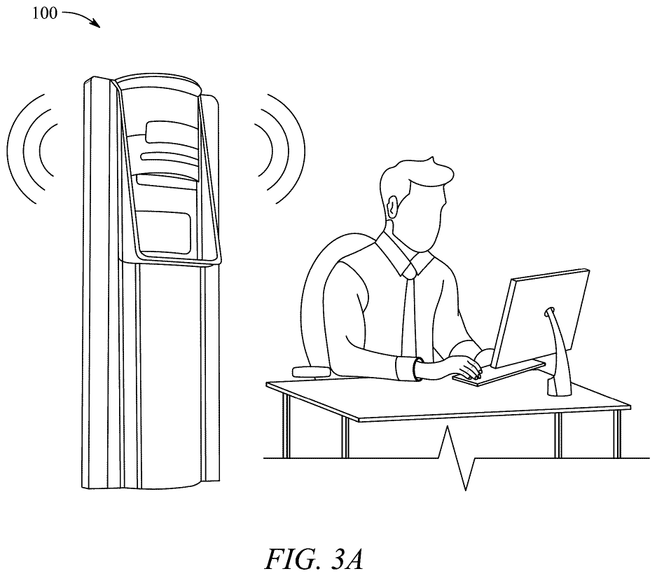

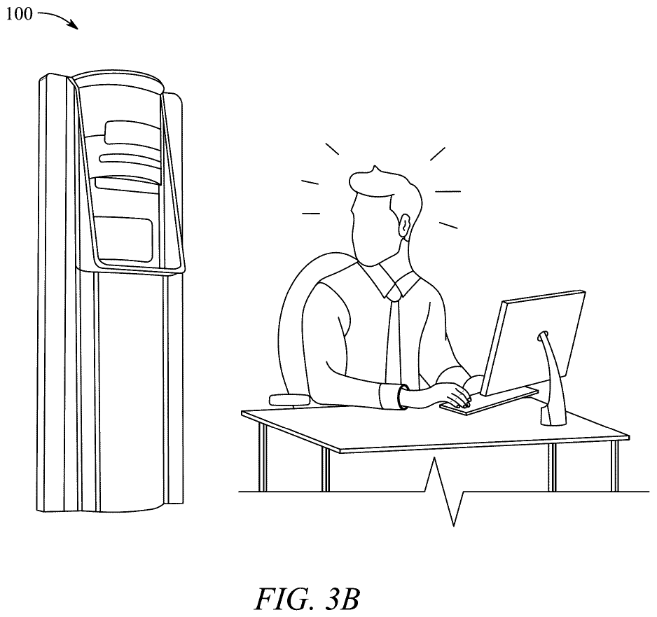

FIGS. 3A and 3B illustrate exemplary operational scenarios of the smart hydration station 100 in a workplace environment. In FIG. 3A, the smart hydration station 100 generates audio alerts through the speaker 178 to indicate water availability (represented by wave patterns emanating from the smart hydration station 100) while a user works at a desk station. FIG. 3B depicts the smart hydration station 100 getting attention of the user, prompting the user to maintain regular water consumption during work hours. The smart hydration station 100 is positioned within the workplace to be readily accessible while maintaining an unobtrusive presence. The integration of the speaker 178 and reminder function enables the smart hydration station 100 to actively promote workplace hydration through automated alerts and reminders. The smart hydration station 100 demonstrates application in various professional settings including office buildings, industrial facilities, healthcare institutions, educational campuses, and fitness centers.

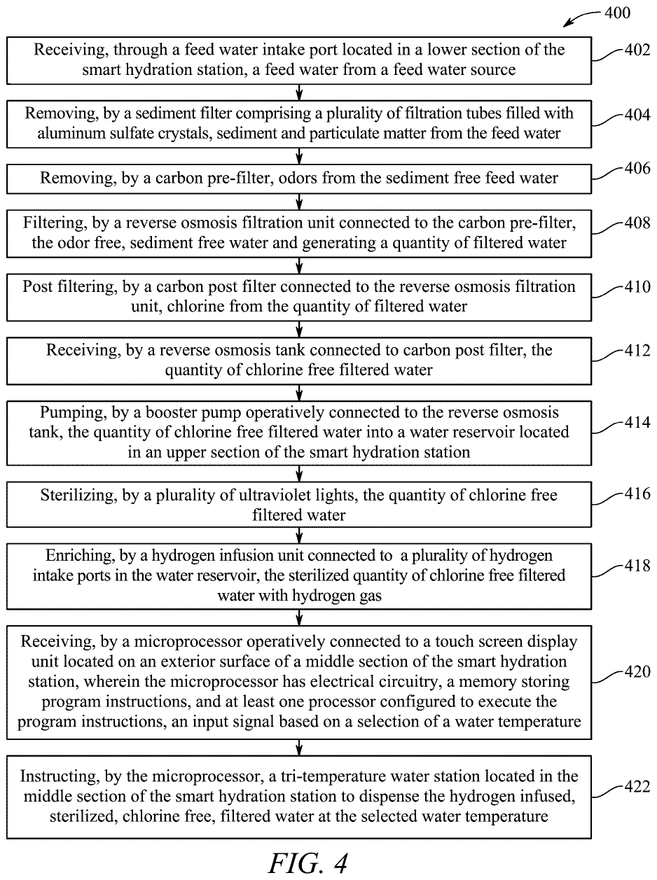

Referring now to FIG. 4, the present disclosure further provides a method (as represented by a flowchart, referred by reference numeral 400) of purifying a feed water by the smart hydration station 100. The method 400 includes a series of steps. These steps are only illustrative, and other alternatives may be considered where one or more steps are added, one or more steps are removed, or one or more steps are provided in a different sequence without departing from the scope of the present disclosure. Various variants disclosed above, with respect to the aforementioned smart hydration station 100 apply mutatis mutandis to the present method 400 of purifying the feed water thereby.

At step 402, the method 400 includes receiving, through the feed water intake port 110 located in the lower section 102 of the smart hydration station 100, the feed water from the feed water source. Herein, the feed water intake port 110, which is positioned at the lower portion of the lower section 102, establishes the secure connection with the feed water source to receive feed water for processing. The feed water intake port 110 incorporates the pressure regulator to maintain optimal input pressure for subsequent filtration processes, and the shutoff valve enables isolation of the smart hydration station 100 from the feed water source during maintenance operations.

At step 404, the method 400 includes removing, by the sediment filter 112 comprising the plurality of filtration tubes 114 filled with aluminum sulfate crystals, sediment and particulate matter from the feed water. During this operation, the feed water passes through the plurality of filtration tubes 114 arranged in the parallel configuration. The aluminum sulfate crystals within each filtration tube 114 are specifically arranged to maximize contact surface area while maintaining consistent flow rates through the sediment filter 112. The sediment filter 112 removes suspended particles, sediment, and turbidity from the feed water through both mechanical filtration and chemical coagulation processes provided by the aluminum sulfate crystals.

At step 406, the method 400 includes removing, by the carbon pre-filter 116, odors from the sediment free feed water. Herein, the carbon pre-filter 116, which may be positioned vertically within the lower section 102 downstream of the sediment filter 112, processes the water through activated carbon media specifically selected for removal of chlorine, organic compounds, and chemical contaminants. The activated carbon media within the carbon pre-filter 116 is configured in the gradient density arrangement to increase contact time and thereby filtration efficiency, while maintaining consistent flow rates through the carbon pre-filter 116.

At step 408, the method 400 includes filtering, by the reverse osmosis filtration unit 118 connected to the carbon pre-filter 116, the odor free, sediment free water and generating a quantity of filtered water. During this step, the reverse osmosis filtration unit 118 receives the pre-filtered water through a high-pressure connection assembly. The semi-permeable membrane within the reverse osmosis filtration unit 118 removes dissolved solids and impurities from the water. The reverse osmosis filtration unit 118 operates under precisely controlled pressure conditions maintained by a pressure regulation system to generate filtered water meeting specific purity standards.

At step 410, the method 400 includes post filtering, by the carbon post filter 120 connected to the reverse osmosis filtration unit 118, chlorine from the quantity of filtered water. Herein, the carbon post filter 120 processes the filtered water through a specialized activated carbon blend housed within a filter cartridge. The carbon post filter 120 serves as a final polishing stage, removing any remaining trace contaminants and improving the taste of the filtered water. The filter monitoring sensor within the carbon post filter 120 provides continuous feedback to the microprocessor 108 to track filter life and performance.

At step 412, the method 400 includes receiving, by the reverse osmosis tank 122 connected to the carbon post filter 120, the quantity of chlorine free filtered water. The reverse osmosis tank 122 stores the filtered water processed through the previous filtration stages. The food-grade butyl rubber bladder within the reverse osmosis tank 122 expands and contracts to accommodate varying water volumes while maintaining system pressure. The float sensor within the reverse osmosis tank 122 monitors water level and communicates with the microprocessor 108 to control the filtration process.

At step 414, the method 400 includes pumping, by the booster pump 126 operatively connected to the reverse osmosis tank 122, the quantity of chlorine free filtered water into the water reservoir 134 located in the upper section 106 of the smart hydration station 100. Herein, the booster pump 126 operates at a pressure range of 40-60 psi to maintain optimal water pressure throughout the smart hydration station 100. The booster pump 126 receives the filtered water through the water pipe 124 from the reverse osmosis tank 122 and pumps the water through the water conveying pipe 128 to the filtered water intake port 130 in the upper section 106.

At step 416, the method 400 includes sterilizing, by the plurality of ultraviolet lights 132, the quantity of chlorine free filtered water. During this operation, the plurality of ultraviolet lights 132, positioned within the water reservoir 134, provide UV exposure to the filtered water. The plurality of ultraviolet lights 132, including four UV-C lights rated at 254 nanometers wavelength, ensure uniform sterilization coverage of the water being processed. The UV intensity sensors may monitor sterilization levels and provide feedback to the microprocessor 108 to maintain proper sterilization efficiency.

At step 418, the method 400 includes enriching, by the hydrogen infusion unit 136 connected to the plurality of hydrogen intake ports 138 in the water reservoir 134, the sterilized quantity of chlorine free filtered water with hydrogen gas. Herein, the hydrogen infusion unit 136 generates hydrogen gas through electrolysis using the electrolyzer cell comprising the cathode platinum electrolytic sheets 202, 204, the cation exchange membrane 206, and the anode platinum electrolytic sheet 208. The generated hydrogen gas is directed through gas transfer lines to the plurality of hydrogen intake ports 138, where micro-bubble diffusers create fine hydrogen bubbles for optimal dissolution into the water.

At step 420, the method 400 includes receiving, by the microprocessor 108 operatively connected to the touch screen display unit 160 located on the exterior surface of the middle section 104 of the smart hydration station 100, an input signal based on a selection of a water temperature. Herein, the microprocessor 108 has electrical circuitry, a memory storing program instructions, and at least one processor configured to execute the program instructions. For this operation, the microprocessor 108 receives user input through the touch screen display unit 160, which presents selectable input buttons including the ON button, the OFF button, the hot water input button, the cold water input button and the selectable temperature input button. The touch screen display unit 160 transmits the temperature selection by the user to the microprocessor 108 through the operatively connected control interfaces.

At step 422, the method 400 includes instructing, by the microprocessor 108, the tri-temperature water station 158 located in the middle section 104 of the smart hydration station 100 to dispense the hydrogen infused, sterilized, chlorine free, filtered water at the selected temperature. Herein, based on the received temperature selection, the microprocessor 108 actuates the first electronically actuated valve 144 to direct water flow through the appropriate output port 146, 148, or 150 of the three-way diverter 142. For hot water, the microprocessor 108 activates the heating element 162 to heat the water. For cold water, the microprocessor 108 activates the refrigeration unit 164 to cool the water. For intermediate temperatures, the microprocessor 108 controls the second electronically actuatable valve 170 to mix hot and cold water based on feedback from the temperature sensor 172 until achieving the selected temperature. The tri-temperature water station 158 then dispenses the temperature-controlled water through the appropriate dispensing nozzle 158a, 158b, or 158c.

In aspects of the present disclosure, the method 400 further includes selecting, from the touch screen display unit 160, one of the plurality of selectable input buttons comprising an ON button, an OFF button, the hot water input button, the cold water input button and the selectable temperature input button. The capacitive touch panel of the touch screen display unit 160 with anti-glare coating enables clear visibility and accurate input detection in various lighting conditions. The method 400 further includes receiving, by the microprocessor 108, the input signal based on the selected input button. The touch screen display unit 160 converts user touch inputs into corresponding electrical signals that are transmitted to the microprocessor 108 for processing.

The method 400 further includes executing, by the at least one processor of the microprocessor 108, the program instructions for connecting the microprocessor 108 to the power source when the ON button is selected. When the ON button is selected, the microprocessor 108 establishes connection with the power source through the power cord 176, activating all electrical and electronic components of the smart hydration station 100 through appropriate power distribution circuitry. The method 400 further includes disconnecting the microprocessor 108 from the power source when the OFF button is selected. When the OFF button is selected, the microprocessor 108 initiates a systematic shutdown of all operational components before disconnecting from the power source through the power cord 176.

The method 400 further includes actuating, by the microprocessor 108, the heating element 162 surrounding the hot water dispensing pipe 152 when the hot water input button is selected. The microprocessor 108 activates the heating element 162 through temperature control circuitry to heat the hydrogen infused, sterilized, filtered water to a pre-set temperature between 85° C. and 95° C. The heating element 162 maintains this temperature range through continuous feedback from temperature sensors monitored by the microprocessor 108. The method 400 further includes actuating, by the microprocessor 108, the refrigeration unit 164 surrounding the cold water dispensing pipe 154 when the cold water input button is selected. The microprocessor 108 activates the compressor and cooling coils of the refrigeration unit 164 to cool the hydrogen infused, sterilized, filtered water to a pre-set temperature between 4° C. and 10° C. The refrigeration unit 164 maintains this temperature range through continuous monitoring and control by the microprocessor 108.

The method 400 further includes actuating, by the microprocessor 108, the second electronically actuatable valve 170 of the two way diverter 168 connected to the hot water dispensing pipe 152 to divert hot water from the hot water dispensing pipe 152 to the hydrogen infused, sterilized, chlorine free, filtered water until the temperature sensor 172 located downstream of the two way diverter 168 records a temperature reading which matches the selectable temperature input. Herein, the microprocessor 108 continuously monitors readings from the temperature sensor 172 and adjusting the second electronically actuatable valve 170 to maintain precise temperature control through controlled mixing of hot and cold water streams.

In an aspect, the method 400 further includes displaying, on the LED display screen 174, the set of operational indicators of the smart hydration station 100 which indicate an operational status. The LED display screen 174, positioned above the touch screen display unit 160, receives display signals from the microprocessor 108 to update any one of the operational indicators in real-time. Herein, the operational status includes displaying the pumping status, indicating the booster pump 126 operation of pumping the chlorine free filtered water into the water reservoir 134. During this operational state, the LED display screen 174 displays tank filling status through illuminated icon-based indicators that show active water transfer from the lower section 102 to the upper section 106. The operational status further includes the sterilization status, indicating the plurality of ultraviolet lights 132 sterilizing the chlorine free filtered water. The LED display screen 174 activates a UV lamp icon when the UV sterilization process is active, with the icon becoming highlighted to confirm proper operation of the plurality of ultraviolet lights 132. The operational status further includes the hydrogen infusion status, indicating the hydrogen infusion unit 136 enriching the sterilized, chlorine free filtered water. When hydrogen infusion is in process, the LED display screen 174 activates a hydrogen bubble icon to indicate active hydrogen gas generation and infusion through the plurality of hydrogen intake ports 138. The operational status further includes the heating status, indicating the heating element 162 heating the hydrogen enriched, sterilized, chlorine free filtered water. The LED display screen 174 displays the active heating status through temperature indicators when the heating element 162 is maintaining the water temperature between 85° C. and 95° C. The operational status further includes the cooling status, indicating the refrigeration unit 164 cooling the hydrogen enriched, sterilized, chlorine free filtered water. The LED display screen 174 provides visual confirmation when the refrigeration unit 164 is actively maintaining water temperature between 4° C. and 10° C. through dedicated cooling status indicators. The operational status further includes the mixing status, indicating the two way diverter 168 mixing the hydrogen enriched, sterilized, chlorine free filtered water to the selected temperature. The LED display screen 174 shows the temperature adjustment process through progressive indicators as the second electronically actuatable valve 170 regulates water mixing to achieve the selected temperature. The operational status further includes the dispensing status, indicating the tri-temperature water station 158 dispensing the hydrogen enriched, sterilized, chlorine free filtered water. The LED display screen 174 provides real-time feedback on water dispensing operations through the hot water dispensing nozzle 158a, the cold water output port 158b, or the selectable temperature dispensing nozzle 158c.

Herein, the microprocessor 108 is operatively connected to the power cord 176, the booster pump 126, the plurality of ultraviolet lights 132, the hydrogen infusion unit 136, the heating element 162, the refrigeration unit 164, the second electronically actuatable valve 170 of the two way diverter 168, the tri-temperature water station 158, and the LED display screen 174. Through these connections, the microprocessor 108 maintains comprehensive control over all operational components of the smart hydration station 100. The at least one processor of the microprocessor 108 is configured for executing the program instructions to display each operational indicator on the LED display screen 174. The microprocessor 108 processes real-time data from all connected components and updates the LED display screen 174 accordingly. The operational indicators include the ON indicator illuminating when the smart hydration station 100 is powered and operational, the OFF indicator illuminating when in standby mode, the READY indicator activating when water is prepared for dispensing, and the process bar displaying sequential progression of water treatment from the lower section 102 through the upper section 106 to the middle section 104.

In an aspect, the method 400 further includes generating, by the speaker 178 operatively connected to the microprocessor 108, an alert when the hydrogen infused, sterilized, chlorine free filtered water at the selected temperature is ready for dispensing. During this operation, the speaker 178, positioned within the middle section 104 and connected through audio control circuitry to the microprocessor 108, produces pre-programmed audio patterns such as a single beep, multiple beeps in a defined sequence, or voice messages indicating water availability. The speaker 178 generates these alerts at different volumes based on ambient noise levels or user preferences programmed through the touch screen display unit 160.

The method 400 further includes generating, by the speaker 178 operatively connected to the microprocessor 108, a periodic reminder to drink the hydrogen infused, sterilized, chlorine free filtered water. The microprocessor 108 generates these periodic reminders through the speaker 178 at customizable time intervals ranging from 30 minutes to 2 hours during designated operational hours, typically aligned with standard workplace schedules (e.g., 9:00 AM to 5:00 PM). The periodic reminder function may be enabled or disabled through the touch screen display unit 160, providing customization according to workplace preferences. The speaker 178 produces varying audio patterns or voice messages to maintain user engagement and promote regular hydration habits in the workplace environment. The microprocessor 108 may adjust reminder timing based on usage patterns or pre-set schedules stored in its memory.

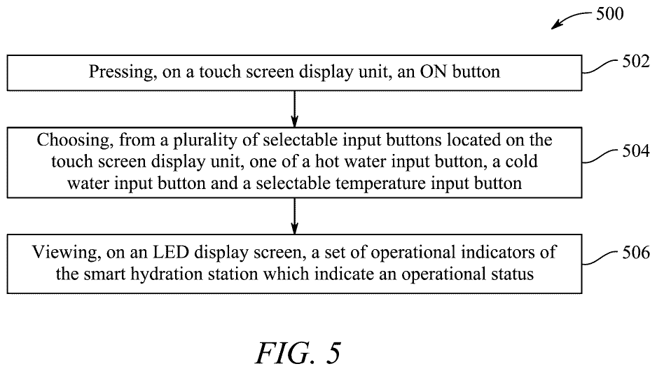

Referring now to FIG. 5, the present disclosure further provides a method (as represented by a flowchart, referred by reference numeral 500) of dispensing hydrogen infused, sterilized, chlorine free filtered water from the smart hydration station 100. The method 500 includes a series of steps. These steps are only illustrative, and other alternatives may be considered where one or more steps are added, one or more steps are removed, or one or more steps are provided in a different sequence without departing from the scope of the present disclosure. Various variants disclosed above, with respect to the aforementioned smart hydration station 100 apply mutatis mutandis to the present method 500 of dispensing hydrogen infused, sterilized, chlorine free filtered water therefrom.

At step 502, the method 500 includes pressing, on the touch screen display unit 160, an ON button. During this step, a user interacts with the capacitive touch panel of the touch screen display unit 160 to initiate system startup. When the ON button is pressed, the touch screen display unit 160 transmits an activation signal to the microprocessor 108, which then establishes connection with the power source through the power cord 176, initiating power distribution to all electrical and electronic components of the smart hydration station 100.

At step 504, the method 500 includes choosing from the plurality of selectable input buttons located on the touch screen display unit 160, one of the hot water input button, the cold water input button and the selectable temperature input button. During this step, after system activation, the touch screen display unit 160 displays the selectable input buttons with distinctive icons and clear labeling. The user selects the desired water temperature option through the anti-glare coated capacitive touch panel, which converts the touch input into corresponding electrical signals transmitted to the microprocessor 108 for processing.

At step 506, the method 500 includes viewing, on the LED display screen 174, the set of operational indicators of the smart hydration station 100 which indicate an operational status. The LED display screen 174, positioned above the touch screen display unit 160, receives display signals from the microprocessor 108 to provide real-time visual feedback about system operations. The LED display screen 174 incorporates multiple icon-based indicators representing different operational states, with each indicator illuminating or animating to show active processing states.

Herein, the method 500 further includes viewing on the LED display screen 174 a receiving status, indicating the feed water intake port 110 located in the lower section 102 of the smart hydration station 100 receiving the feed water from the feed water source. This operational indicator shows the initial water intake process, including pressure regulation and flow status at the feed water intake port 110. The method 500 further includes viewing on the LED display screen 174 a removing status, indicating the sediment filter 112, which comprises the plurality of filtration tubes 114 filled with aluminum sulfate crystals, removing sediment and particulate matter from the feed water. The LED display screen 174 displays such status of this initial filtration stage through dedicated indicators showing particle removal operations. The method 500 further includes viewing on the LED display screen 174 a removing status, indicating the carbon pre-filter 116 removing odors from the sediment free feed water. This indicator shows the active carbon filtration process as water passes through the activated carbon media within the carbon pre-filter 116. The method 500 further includes viewing on the LED display screen 174 a filtering status, indicating the reverse osmosis filtration unit 118 connected to the carbon pre-filter 116 filtering the odor free, sediment free water and generating the quantity of filtered water. The LED display screen 174 provides visual confirmation of proper reverse osmosis operation through dedicated status indicators.

The method 500 further includes viewing on the LED display screen 174 a post-filtering status, indicating the carbon post filter 120 connected to the reverse osmosis filtration unit 118 removing chlorine from the quantity of filtered water. The LED display screen 174 displays active status of this final filtration stage through designated indicators showing the polishing process. The method 500 further includes viewing on the LED display screen 174 a receiving status, indicating the reverse osmosis tank 122 connected to the carbon post filter 120 receiving the quantity of chlorine free filtered water. This operational indicator shows water level and storage status within the reverse osmosis tank 122 through specific icons or level indicators. The method 500 further includes viewing on the LED display screen 174 a pumping status, indicating the booster pump 126 pumping the chlorine free filtered water from the reverse osmosis tank 122 into the water reservoir 134. The LED display screen 174 provides visual confirmation of active water transfer between the lower section 102 and upper section 106 through dedicated pumping status indicators. The method 500 further includes viewing on the LED display screen 174 a sterilizing status, indicating the plurality of ultraviolet lights 132 sterilizing the chlorine free filtered water in the water reservoir 134. When UV sterilization is active, the LED display screen 174 illuminates a UV lamp icon to confirm proper operation of the sterilization process.

The method 500 further includes viewing on the LED display screen 174 an enriching status, indicating the hydrogen infusion unit 136 enriching the sterilized, chlorine free filtered water. The LED display screen 174 activates a hydrogen bubble icon when the electrolyzer cell of the hydrogen infusion unit 136 is generating and infusing hydrogen through the plurality of hydrogen intake ports 138. The method 500 further includes viewing on the LED display screen 174 a heating status, indicating the heating element 162 heating the hydrogen enriched, sterilized, chlorine free filtered water when the hot water input button is pressed. The LED display screen 174 displays active heating operations through temperature indicators as the heating element 162 maintains water temperature between 85° C. and 95° C. The method 500 further includes viewing on the LED display screen 174 a cooling status, indicating the refrigeration unit 164 cooling the hydrogen enriched, sterilized, chlorine free filtered water when the cold water input button is pressed. The LED display screen 174 shows active cooling operations through dedicated indicators as the refrigeration unit 164 maintains water temperature between 4° C. and 10° C. The method 500 further includes viewing on the LED display screen 174 a mixing status, indicating the two way diverter 168 mixing the hydrogen enriched, sterilized, chlorine free filtered water to the selected temperature when the selectable temperature input button is pressed. The LED display screen 174 displays the temperature adjustment process through progressive indicators as the second electronically actuatable valve 170 regulates water mixing. The method 500 further includes viewing on the LED display screen 174 a dispensing status, indicating the tri-temperature water station 158 dispensing the hydrogen enriched, sterilized, chlorine free filtered water. The LED display screen 174 provides real-time feedback of water dispensing operations through specific indicators corresponding to active dispensing through the hot water dispensing nozzle 158a, the cold water output port 158b, or the selectable temperature dispensing nozzle 158c.

In some aspects, the method 500 further includes receiving, from the speaker 178 operatively connected to the microprocessor 108, an alert when the hydrogen infused, sterilized, chlorine free filtered water at the selected temperature is ready for dispensing. During this step, the speaker 178 positioned within the middle section 104 generates audible alerts through pre-programmed audio patterns such as a single beep, multiple beeps in a defined sequence, or voice messages. The speaker 178 produces these alerts at volumes adjusted based on ambient noise levels or user preferences programmed through the touch screen display unit 160, confirming water availability at the selected temperature. The method 500 further includes dispensing, from the tri-temperature water station 158, the hydrogen enriched, sterilized, chlorine free filtered water at the selected temperature upon receiving, from the speaker 178 operatively connected to the microprocessor 108, a reminder to drink the hydrogen infused, sterilized, chlorine free filtered water. During this step, the microprocessor 108 generates periodic reminders through the speaker 178 at customizable time intervals ranging from 30 minutes to 2 hours during designated operational hours (e.g., 9:00 AM to 5:00 PM). Upon receiving these audio reminders, which may include varying audio patterns or voice messages, users can obtain water from the appropriate dispensing nozzle 158a, 158b, or 158c of the tri-temperature water station 158.

The smart hydration station 100 and the method 400, 500 of the present disclosure provide comprehensive water treatment and dispensing capabilities through integration of multiple processing stages in a unified system. The smart hydration station 100 combines staged filtration including aluminum sulfate crystal sediment removal, carbon pre and post filtering, and reverse osmosis purification, with advanced treatment features including UV sterilization and hydrogen gas infusion. The microprocessor 108 coordinates all operations of the smart hydration station 100, managing water processing from initial intake through final temperature-controlled dispensing while providing real-time status updates through the LED display screen 174 and audio alerts through the speaker 178.

The smart hydration station 100 addresses key limitations of existing water dispensing systems through several distinct features. The sediment filter 112 incorporating aluminum sulfate crystals provides superior particle removal compared to conventional filters. The hydrogen infusion unit 136 with the electrolyzer cell configuration enriches water with beneficial hydrogen gas, while the plurality of ultraviolet lights 132 ensure comprehensive sterilization. The tri-temperature water station 158 offers precise temperature control through the combination of the heating element 162, the refrigeration unit 164, and the two way diverter 168, enabling dispensing at exact user-selected temperatures. The smart hydration station 100 eliminates the need for bottled water delivery and maintains consistent water quality through continuous monitoring and automated controls.

The smart hydration station 100 enhances user engagement and promotes regular hydration through intelligent interface features. The touch screen display unit 160 provides intuitive temperature selection and operational control, while the LED display screen 174 offers clear visual feedback of all processing stages. The speaker 178 generates timely alerts and reminders, encouraging consistent water consumption throughout workplace hours. The ergonomic design with the tri-temperature water station 158 at appropriate height ensures comfortable access, while the modular construction of the sections 102-106 facilitates maintenance and servicing operations.

A first embodiment describes a smart hydration station 100, comprising: a lower section 102 including: a feed water intake port 110 configured to connect to a feed water source; a sediment filter 112 connected to the feed water intake port 110; a carbon pre-filter 116 connected to the sediment filter 112; a reverse osmosis filtration unit 118 connected to the carbon pre-filter 116, wherein the reverse osmosis filtration unit 118 is configured to receive a volume of water from the carbon pre-filter 116 and generate filtered water; a carbon post filter 120 connected to the reverse osmosis filtration unit 118; a reverse osmosis tank 122 connected to carbon post filter 120; a water pipe 124 having a first end 124a connected to the reverse osmosis tank 122; a booster pump 126 connected to a second end 124b of the water pipe 124; a water conveying pipe 128 having a first end 128a connected to the booster pump 126; an upper section 106 including: a filtered water intake port 130 connected to receive the filtered water from the water conveying pipe 128; a plurality of ultraviolet lights 132 configured to sterilize the filtered water; a hydrogen infusion unit 136 configured to enrich the sterilized, filtered water with hydrogen; a middle section 104 connected to the hydrogen infusion unit 136, wherein the middle section 104 includes a tri-temperature water station 158 configured to dispense the hydrogen infused, sterilized, filtered water at a selected temperature; and a microprocessor 108 having electrical circuitry, a memory storing program instructions, and at least one processor configured to execute the program instructions to dispense the hydrogen infused, sterilized, filtered water from the tri-temperature water station 158 at the selected temperature.

In an aspect, the sediment filter 112 comprises a plurality of filtration tubes 114 filled with aluminum sulfate crystals.

In an aspect, the upper section 106 further comprises: a water reservoir 134 connected to the filtered water intake port 130; at least one ultraviolet light 132 located at least partially within the water reservoir 134; and a plurality of hydrogen intake ports 138 located on the water reservoir 134, wherein the plurality of hydrogen intake ports 138 are configured to receive a hydrogen gas from the hydrogen infusion unit 136.

In an aspect, the middle section 104 further comprises: a water receiving pipe 140 connected to the water reservoir 134, wherein the water receiving pipe 140 is configured to receive the filtered, sterilized, hydrogen infused water from the water reservoir 134; a three-way diverter 142 connected to the water receiving pipe 140, wherein the three-way diverter 142 includes a first electronically actuated valve 144 configured to direct the filtered, sterilized, hydrogen infused water into at least one of a first output port 146, a second output port 148 and a third output port 150; a hot water dispensing pipe 152 connected to the first output port 146 of the three-way diverter 142; a cold water dispensing pipe 154 connected to the second output port 148 of the three-way diverter 142; and an intermediate pipe 156 connected to the third output port 150 of the three-way diverter 142.

In an aspect, the smart hydration station 100, further comprises: a touch screen display unit 160 located on an exterior surface of the middle section 104, wherein the touch screen display unit 160 is configured with selectable input buttons comprising an ON button, an OFF button, a hot water input button, a cold water input button and a selectable temperature input button, wherein the microprocessor 108 is operatively connected to the touch screen display unit 160 and is configured to receive signals based on a selection of an input button.

In an aspect, the smart hydration station 100, further comprises: wherein the microprocessor 108 is configured to actuate the first electronically actuated valve 144 to divert the hydrogen infused, sterilized, filtered water to the hot water dispensing pipe 152 when the hot water input button is selected; a heating element 162 surrounding a portion of the hot water dispensing pipe 152, wherein the heating element 162 is configured to heat the hydrogen infused, sterilized, filtered water to a pre-set hot water temperature when the hot water input button is selected; and a hot water dispensing nozzle 158a located in the tri-temperature water station 158, wherein the hot water dispensing nozzle 158a is connected to the hot water dispensing pipe 152 and wherein the hot water dispensing nozzle 158a is configured to dispense the heated hydrogen infused, sterilized, filtered water.

In an aspect, the microprocessor 108 is configured to actuate the first electronically actuated valve 144 to divert the hydrogen infused, sterilized, filtered water to the cold water dispensing pipe 154 when the cold water input button is selected, wherein the middle section 104 further includes: a refrigeration unit 164 connected to the cold water dispensing pipe 154, wherein the refrigeration unit 164 is configured to cool the hydrogen infused, sterilized, filtered water to a pre-set cold water temperature when the cold water input button is selected; and a cold water output port 158b located in the tri-temperature water station 158, wherein the cold water output port 158b is connected to the cold water dispensing pipe 154 and wherein the cold water output port 158b is configured to dispense the cooled hydrogen infused, sterilized, filtered water.

In an aspect, the smart hydration station 100, further comprises: a coupler 166 connected to the intermediate pipe 156; a two way diverter 168 configured to connect to the coupler 166 and to the hot water dispensing pipe 152, wherein the two way diverter 168 includes a second electronically actuatable valve 170; a temperature sensor 172 located on the intermediate pipe 156 downstream of the coupler 166, wherein the microprocessor 108 is configured to receive a temperature reading from the temperature sensor 172 and a selected temperature from the selectable temperature input button and actuate the second electronically actuated valve to divert hot water from the hot water dispensing pipe 152 to the intermediate pipe 156 until the temperature reading matches the selected temperature; and a selectable temperature dispensing nozzle 158c connected to the intermediate pipe 156 downstream of the coupler 166, wherein the selectable temperature dispensing nozzle 158c is configured to dispense the hydrogen infused, sterilized, filtered water at the selected temperature.

In an aspect, the smart hydration station 100, further comprises: an LED display screen 174 configured to display a set of operational indicators of the smart hydration station 100; a power cord 176 configured to connect to a power source; and an electronics housing 109 located behind the touch screen display unit 160, wherein the microprocessor 108 is located within the electronics housing 109, wherein the microprocessor 108 is operatively connected to the power cord 176, the booster pump 126, the ultraviolet lights 132, the hydrogen infusion unit 136, and the LED display screen 174, wherein the at least one processor is configured to execute the program instructions when an ON input is received on the touch screen display.

In an aspect, the set of operational indicators include an ON indicator, and OFF indicator, a READY indicator and process bar configured to display a status of a progress of the hydrogen infused, sterilized, filtered water from the lower section 102 through the upper section 106 to the middle section 104.

In an aspect, the smart hydration station 100, further comprises a speaker 178 operatively connected to the microprocessor 108, wherein the microprocessor 108 is configured to generate an alert when the hydrogen infused, sterilized, filtered water at the selected temperature is ready to be dispensed.

In an aspect, the microprocessor 108 is configured to generate a periodic reminder to drink the hydrogen infused, sterilized, filtered water.

In an aspect, the smart hydration station 100 has a height from a lower surface of the lower section 102 to an upper surface of the upper section 106 of about 167 cm, a width of about 38 cm and a depth of about 38 cm, and a height from the lower surface of the lower section 102 to a lower surface of the tri-temperature water station 158 of about 90.5 cm.

A second embodiment describes a method 400 of purifying a feed water by a smart hydration station 100, comprising: receiving, through a feed water intake port 110 located in a lower section 102 of the smart hydration station 100, a feed water from a feed water source; removing, by a sediment filter 112 comprising a plurality of filtration tubes 114 filled with aluminum sulfate crystals, sediment and particulate matter from the feed water; removing, by a carbon pre-filter 116, odors from the sediment free feed water; filtering, by a reverse osmosis filtration unit 118 connected to the carbon pre-filter 116, the odor free, sediment free water and generating a quantity of filtered water; post filtering, by a carbon post filter 120 connected to the reverse osmosis filtration unit 118, chlorine from the quantity of filtered water; receiving, by a reverse osmosis tank 122 connected to carbon post filter 120, the quantity of chlorine free filtered water; pumping, by a booster pump 126 operatively connected to the reverse osmosis tank 122, the quantity of chlorine free filtered water into a water reservoir 134 located in an upper section 106 of the smart hydration station 100; sterilizing, by a plurality of ultraviolet lights 132, the quantity of chlorine free filtered water; enriching, by a hydrogen infusion unit 136 connected to a plurality of hydrogen intake ports 138 in the water reservoir 134, the sterilized quantity of chlorine free filtered water with hydrogen gas; receiving, by a microprocessor 108 operatively connected to a touch screen display unit 160 located on an exterior surface of a middle section 104 of the smart hydration station 100, wherein the microprocessor 108 has electrical circuitry, a memory storing program instructions, and at least one processor configured to execute the program instructions, an input signal based on a selection of a water temperature; and instructing, by the microprocessor 108, a tri-temperature water station 158 located in the middle section 104 of the smart hydration station 100 to dispense the hydrogen infused, sterilized, chlorine free, filtered water at the selected water temperature.

In an aspect, the method 400, further comprises: selecting, from the touch screen display unit 160, one of a plurality of selectable input buttons comprising an ON button, an OFF button, a hot water input button, a cold water input button and a selectable temperature input button; receiving, by the microprocessor 108, the input signal based on the selected input button; executing, by the at least one processor, the program instructions for: connecting the microprocessor 108 to a power source when the ON button is selected; disconnecting the microprocessor 108 from the power source when the OFF button is selected; actuating, by the microprocessor 108, a heater surrounding a hot water dispensing pipe 152 when the hot water input button is selected; actuating, by the microprocessor 108, a refrigeration unit 164 surrounding a cold water dispensing pipe 154 when the cold water input button is selected; and actuating, by the microprocessor 108, an electronically actuatable valve of a two way diverter 168 connected to the hot water pipe to divert hot water from the hot water dispensing pipe 152 to the hydrogen infused, sterilized, chlorine free, filtered water until a temperature sensor 172 located downstream of the two way diverter 168 records a temperature reading which matches the selectable temperature input.

In an aspect, the method 400, further comprises: displaying, on an LED display screen 174, a set of operational indicators of the smart hydration station 100 which indicate an operational status comprising any one of: the pumping, by the booster pump 126, the chlorine free filtered water into the water reservoir 134, the sterilizing of the chlorine free filtered water by the plurality of ultraviolet lights 132, the enriching, by the hydrogen infusion unit 136, of the sterilized, chlorine free filtered water, the heating, by the heater, of the hydrogen enriched, sterilized, chlorine free filtered water, the cooling, by the refrigeration unit 164, of the hydrogen enriched, sterilized, chlorine free filtered water, the mixing, by the two way diverter 168, of the hydrogen enriched, sterilized, chlorine free filtered water to the selected temperature, and a dispensing status, by the tri-temperature water station 158, of the hydrogen enriched, sterilized, chlorine free filtered water, wherein the microprocessor 108 is operatively connected to a power cord 176, the booster pump 126, plurality of ultraviolet lights 132, the hydrogen infusion unit 136, the heater, the refrigeration unit 164, an electronically actuatable valve of the two way diverter 168, the tri-temperature water station 158 and the LED display screen 174, wherein the at least one processor is configured for executing the program instructions to display each operational indicator on the LED display screen 174.

In an aspect, the method 400, further comprises: generating, by a speaker 178 operatively connected to the microprocessor 108, an alert when the hydrogen infused, sterilized, chlorine free filtered water at the selected temperature is ready for dispensing.

In an aspect, the method 400, further comprises: generating, by a speaker 178 operatively connected to the microprocessor 108, a periodic reminder to drink the hydrogen infused, sterilized, chlorine free filtered water.

A third embodiment describes a method 500 of dispensing hydrogen infused, sterilized, chlorine free filtered water from a smart hydration station 100, comprising: pressing, on a touch screen display unit 160, an ON button; choosing, from a plurality of selectable input buttons located on the touch screen display unit 160, one of a hot water input button, a cold water input button and a selectable temperature input button; viewing, on an LED display screen 174, a set of operational indicators of the smart hydration station 100 which indicate an operational status comprising any one of: a receiving, through a feed water intake port 110 located in a lower section 102 of the smart hydration station 100, a feed water from a feed water source; a removing, by a sediment filter 112 comprising a plurality of filtration tubes 114 filled with aluminum sulfate crystals, sediment and particulate matter from the feed water; a removing, by a carbon pre-filter 116, odors from the sediment free feed water; a filtering, by a reverse osmosis filtration unit 118 connected to the carbon pre-filter 116, the odor free, sediment free water and generating a quantity of filtered water; a post filtering, by a carbon post filter 120 connected to the reverse osmosis filtration unit 118, chlorine from the quantity of filtered water; a receiving, by a reverse osmosis tank 122 connected to carbon post filter 120, the quantity of chlorine free filtered water; a pumping, by a booster pump 126, the chlorine free filtered water from the reverse osmosis tank 122 into a water reservoir 134, a sterilizing of the chlorine free filtered water in the water reservoir 134 by a plurality of ultraviolet lights 132, an enriching, by a hydrogen infusion unit 136, of the sterilized, chlorine free filtered water, a heating, by a heater, of the hydrogen enriched, sterilized, chlorine free filtered water when the hot water input button is pressed, a cooling, by a refrigeration unit 164, of the hydrogen enriched, sterilized, chlorine free filtered water when the cold water input button is pressed, a mixing, by a two way diverter 168, of the hydrogen enriched, sterilized, chlorine free filtered water to a selected temperature when the selectable temperature input button, and a dispensing status, by the tri-temperature water station 158, of the hydrogen enriched, sterilized, chlorine free filtered water.

In an aspect, the method 500, further comprises one or more of: receiving, from a speaker 178 operatively connected to the microprocessor 108, an alert when the hydrogen infused, sterilized, chlorine free filtered water at the selected temperature is ready for dispensing; and dispensing, from the tri-temperature water station 158, the hydrogen enriched, sterilized, chlorine free filtered water at the selected temperature upon receiving, from a speaker 178 operatively connected to the microprocessor 108, a reminder to drink the hydrogen infused, sterilized, chlorine free filtered water.

Next, further details of the hardware description of a computing environment according to exemplary embodiments is described with reference to FIG. 6. In FIG. 6, a controller 600 is described which is representative of the microprocessor 108 of the smart hydration station 100, in which the controller 600 is a computing device which includes a CPU 601 which performs the processes described above/below. The process data and instructions may be stored in memory 602. These processes and instructions may also be stored on a storage medium disk 604 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 601, 603 and an operating system such as Microsoft Windows 7, Microsoft Windows 8, Microsoft Windows 10, UNIX, Solaris, LINUX, Apple MAC-OS and other systems known to those skilled in the art.

The hardware elements in order to achieve the computing device may be realized by various circuitry elements, known to those skilled in the art. For example, CPU 601 or CPU 603 may be a Xenon or Core processor from Intel of America or an Opteron processor from AMD of America, or may be other processor types that would be recognized by one of ordinary skill in the art. Alternatively, the CPU 601, 603 may be implemented on an FPGA, ASIC, PLD or using discrete logic circuits, as one of ordinary skill in the art would recognize. Further, CPU 601, 603 may be implemented as multiple processors cooperatively working in parallel to perform the instructions of the inventive processes described above.

The computing device in FIG. 6 also includes a network controller 606, such as an Intel Ethernet PRO network interface card from Intel Corporation of America, for interfacing with network 660. As can be appreciated, the network 660 can be a public network, such as the Internet, or a private network such as an LAN or WAN network, or any combination thereof and can also include PSTN or ISDN sub-networks. The network 660 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The computing device further includes a display controller 608, such as a NVIDIA GeForce GTX or Quadro graphics adaptor from NVIDIA Corporation of America for interfacing with display 610, such as a Hewlett Packard HPL2445w LCD monitor. A general purpose I/O interface 612 interfaces with a keyboard and/or mouse 614 as well as a touch screen panel 616 on or separate from display 610. General purpose I/O interface also connects to a variety of peripherals 618 including printers and scanners, such as an OfficeJet or DeskJet from Hewlett Packard.

A sound controller 620 is also provided in the computing device such as Sound Blaster X-Fi Titanium from Creative, to interface with speakers/microphone 622 thereby providing sounds and/or music.

The general purpose storage controller 624 connects the storage medium disk 604 with communication bus 626, which may be an ISA, EISA, VESA, PCI, or similar, for interconnecting all of the components of the computing device. A description of the general features and functionality of the display 610, keyboard and/or mouse 614, as well as the display controller 608, storage controller 624, network controller 606, sound controller 620, and general purpose I/O interface 612 is omitted herein for brevity as these features are known.

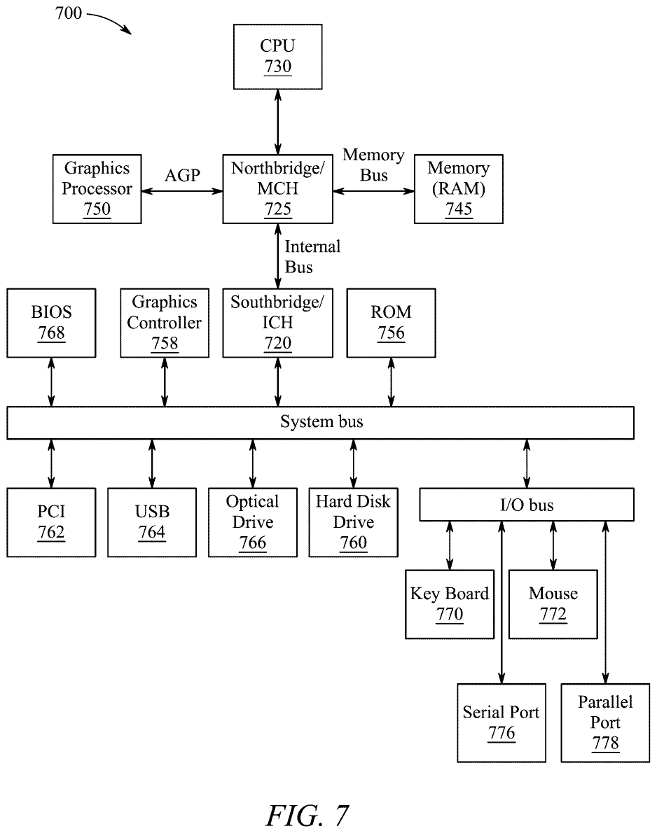

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 7.

FIG. 7 shows a schematic diagram of a data processing system, according to certain embodiments, for performing the functions of the exemplary embodiments. The data processing system is an example of a computer in which code or instructions implementing the processes of the illustrative embodiments may be located.

In FIG. 7, data processing system 700 employs a hub architecture including a north bridge and memory controller hub (NB/MCH) 725 and a south bridge and input/output (I/O) controller hub (SB/ICH) 720. The central processing unit (CPU) 730 is connected to NB/MCH 725. The NB/MCH 725 also connects to the memory 745 via a memory bus and connects to the graphics processor 750 via an accelerated graphics port (AGP). The NB/MCH 725 also connects to the SB/ICH 720 via an internal bus (e.g., a unified media interface or a direct media interface). The CPU Processing unit 730 may contain one or more processors and even may be implemented using one or more heterogeneous processor systems.

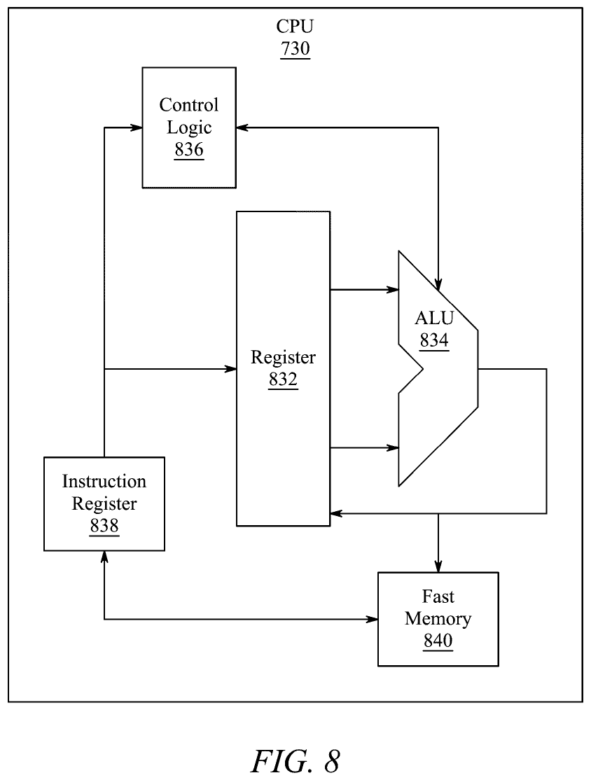

For example, FIG. 8 shows one implementation of CPU 730. In one implementation, the instruction register 838 retrieves instructions from the fast memory 840. At least part of these instructions are fetched from the instruction register 838 by the control logic 836 and interpreted according to the instruction set architecture of the CPU 730. Part of the instructions can also be directed to the register 832. In one implementation the instructions are decoded according to a hardwired method, and in another implementation the instructions are decoded according to a microprogram that translates instructions into sets of CPU configuration signals that are applied sequentially over multiple clock pulses. After fetching and decoding the instructions, the instructions are executed using the arithmetic logic unit (ALU) 834 that loads values from the register 832 and performs logical and mathematical operations on the loaded values according to the instructions. The results from these operations can be feedback into the register and/or stored in the fast memory 840. According to certain implementations, the instruction set architecture of the CPU 730 can use a reduced instruction set architecture, a complex instruction set architecture, a vector processor architecture, a very large instruction word architecture. Furthermore, the CPU 730 can be based on the Von Neuman model or the Harvard model. The CPU 730 can be a digital signal processor, an FPGA, an ASIC, a PLA, a PLD, or a CPLD. Further, the CPU 730 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 7, the data processing system 700 can include that the SB/ICH 720 is coupled through a system bus to an I/O Bus, a read only memory (ROM) 756, universal serial bus (USB) port 764, a flash binary input/output system (BIOS) 768, and a graphics controller 758. PCI/PCIe devices can also be coupled to SB/ICH 788 through a PCI bus 762.

The PCI devices may include, for example, Ethernet adapters, add-in cards, and PC cards for notebook computers. The Hard disk drive 760 and CD-ROM 766 can use, for example, an integrated drive electronics (IDE) or serial advanced technology attachment (SATA) interface. In one implementation the I/O bus can include a super I/O (SIO) device.

Further, the hard disk drive (HDD) 760 and optical drive 766 can also be coupled to the SB/ICH 720 through a system bus. In one implementation, a keyboard 770, a mouse 772, a parallel port 778, and a serial port 776 can be connected to the system bus through the I/O bus. Other peripherals and devices that can be connected to the SB/ICH 720 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

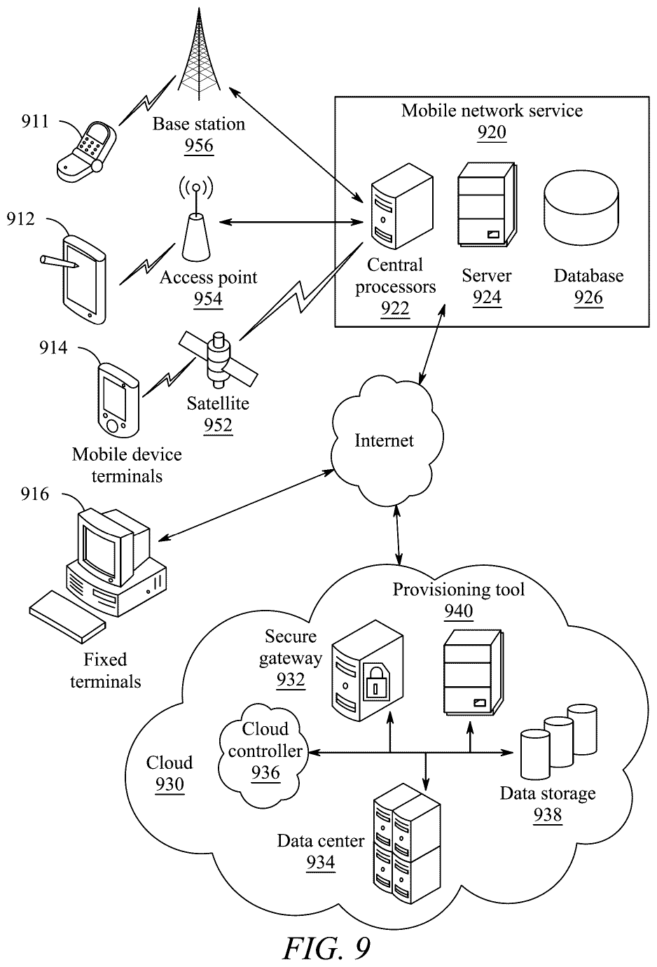

The functions and features described herein may also be executed by various distributed components of a system. For example, one or more processors may execute these system functions, wherein the processors are distributed across multiple components communicating in a network. The distributed components may include one or more client and server machines, such as cloud 930 including a cloud controller 936, a secure gateway 932, a data center 934, data storage 938 and a provisioning tool 940, and mobile network services 920 including central processors 922, a server 924 and a database 926, which may share processing, as shown by FIG. 9, in addition to various human interface and communication devices (e.g., display monitors 916, smart phones 910, tablets 912, personal digital assistants (PDAs) 914). The network may be a private network, such as a LAN, satellite 952 or WAN 954, or be a public network, may such as the Internet. Input to the system may be received via direct user input and received remotely either in real-time or as a batch process. Additionally, some implementations may be performed on modules or hardware not identical to those described. Accordingly, other implementations are within the scope that may be claimed.

While specific embodiments of the invention have been described, it should be understood that various modifications and alternatives may be implemented without departing from the spirit and scope of the invention. For example, different cellular automata rules or encryption algorithms could be employed, or alternative feature extraction and face recognition techniques could be integrated into the system.

The above-described hardware description is a non-limiting example of corresponding structure for performing the functionality described herein.

Numerous modifications and variations of the present disclosure are possible in light of the above teachings. It is therefore to be understood that within the scope of the appended claims, the invention may be practiced otherwise than as specifically described herein.

1. A smart hydration station, comprising:
a lower section including:
a feed water intake port configured to connect to a feed water source;
a sediment filter connected to the feed water intake port;
a carbon pre-filter connected to the sediment filter;
a reverse osmosis filtration unit connected to the carbon pre-filter, wherein the reverse osmosis filtration unit is configured to receive a volume of water from the carbon pre-filter and generate filtered water;
a carbon post filter connected to the reverse osmosis filtration unit;
a reverse osmosis tank connected to the carbon post filter;
a water pipe having a first end connected to the reverse osmosis tank;
a booster pump connected to a second end of the water pipe;
a water conveying pipe having a first end connected to the booster pump;
an upper section including:
a filtered water intake port connected to receive the filtered water from the water conveying pipe;
a plurality of ultraviolet lights configured to sterilize the filtered water;
a hydrogen infusion unit configured to enrich the sterilized, filtered water with hydrogen;
a middle section connected to the hydrogen infusion unit, wherein the middle section includes a tri-temperature water station configured to dispense the hydrogen infused, sterilized, filtered water at a selected temperature; and
a microprocessor having electrical circuitry, a memory storing program instructions, and at least one processor configured to execute the program instructions to dispense the hydrogen infused, sterilized, filtered water from the tri-temperature water station at the selected temperature.

2. The smart hydration station of claim 1, wherein the sediment filter comprises a plurality of filtration tubes filled with aluminum sulfate crystals.

3. The smart hydration station of claim 1, wherein the upper section further comprises:
a water reservoir connected to the filtered water intake port;
at least one ultraviolet light located at least partially within the water reservoir; and
a plurality of hydrogen intake ports located on the water reservoir, wherein the plurality of hydrogen intake ports are configured to receive a hydrogen gas from the hydrogen infusion unit.

4. The smart hydration station of claim 3, wherein the middle section further comprises:
a water receiving pipe connected to the water reservoir, wherein the water receiving pipe is configured to receive the filtered, sterilized, hydrogen infused water from the water reservoir;
a three-way diverter connected to the water receiving pipe, wherein the three-way diverter includes a first electronically actuated valve configured to direct the filtered, sterilized, hydrogen infused water into at least one of a first output port, a second output port and a third output port;
a hot water dispensing pipe connected to the first output port of the three-way diverter;
a cold water dispensing pipe connected to the second output port of the three-way diverter; and
an intermediate pipe connected to the third output port of the three-way diverter.

5. The smart hydration station of claim 4, further comprising:
a touch screen display unit located on an exterior surface of the middle section, wherein the touch screen display unit is configured with selectable input buttons comprising an ON button, an OFF button, a hot water input button, a cold water input button and a selectable temperature input button, wherein the microprocessor is operatively connected to the touch screen display unit and is configured to receive signals based on a selection of an input button.

6. The smart hydration station of claim 5, further comprising:
wherein the microprocessor is configured to actuate the first electronically actuated valve to divert the hydrogen infused, sterilized, filtered water to the hot water dispensing pipe when the hot water input button is selected;
a heating element surrounding a portion of the hot water dispensing pipe, wherein the heating element is configured to heat the hydrogen infused, sterilized, filtered water to a pre-set hot water temperature when the hot water input button is selected; and
a hot water dispensing nozzle located in the tri-temperature water station, wherein the hot water dispensing nozzle is connected to the hot water dispensing pipe and wherein the hot water dispensing nozzle is configured to dispense the heated hydrogen infused, sterilized, filtered water.

7. The smart hydration station of claim 6, wherein:
the microprocessor is configured to actuate the first electronically actuated valve to divert the hydrogen infused, sterilized, filtered water to the cold water dispensing pipe when the cold water input button is selected,
wherein the middle section further includes:
a refrigeration unit connected to the cold water dispensing pipe, wherein the refrigeration unit is configured to cool the hydrogen infused, sterilized, filtered water to a pre-set cold water temperature when the cold water input button is selected; and
a cold water output port located in the tri-temperature water station, wherein the cold water output port is connected to the cold water dispensing pipe and wherein the cold water output port is configured to dispense the cooled hydrogen infused, sterilized, filtered water.

8. The smart hydration station of claim 7, further comprising:
a coupler connected to the intermediate pipe;
a two way diverter configured to connect to the coupler and to the hot water dispensing pipe, wherein the two way diverter includes a second electronically actuatable valve;
a temperature sensor located on the intermediate pipe downstream of the coupler,
wherein the microprocessor is configured to receive a temperature reading from the temperature sensor and a selected temperature from the selectable temperature input button and actuate the second electronically actuated valve to divert hot water from the hot water dispensing pipe to the intermediate pipe until the temperature reading matches the selected temperature; and
a selectable temperature dispensing nozzle connected to the intermediate pipe downstream of the coupler, wherein the selectable temperature dispensing nozzle is configured to dispense the hydrogen infused, sterilized, filtered water at the selected temperature.

9. The smart hydration station of claim 1, further comprising:
an LED display screen configured to display a set of operational indicators of the smart hydration station;
a power cord configured to connect to a power source; and
an electronics housing located behind the touch screen display unit, wherein the microprocessor is located within the electronics housing, wherein the microprocessor is operatively connected to the power cord, the booster pump, the ultraviolet lights, the hydrogen infusion unit, and the LED display screen, wherein the at least one processor is configured to execute the program instructions when an ON input is received on the touch screen display.

10. The smart hydration station of claim 9, wherein the set of operational indicators include an ON indicator, and OFF indicator, a READY indicator and process bar configured to display a status of a progress of the hydrogen infused, sterilized, filtered water from the lower section through the upper section to the middle section.

11. The smart hydration station of claim 10, further comprising:
a speaker operatively connected to the microprocessor, wherein the microprocessor is configured to generate an alert when the hydrogen infused, sterilized, filtered water at the selected temperature is ready to be dispensed.

12. The smart hydration station of claim 11, wherein the microprocessor is configured to generate a periodic reminder to drink the hydrogen infused, sterilized, filtered water.

13. The smart hydration station of claim 11, wherein the smart hydration station has a height from a lower surface of the lower section to an upper surface of the upper section of about 167 cm, a width of about 38 cm and a depth of about 38 cm, and a height from the lower surface of the lower section to a lower surface of the tri-temperature water station of about 90.5 cm.

14. A method of purifying a feed water by a smart hydration station, comprising:
receiving, through a feed water intake port located in a lower section of the smart hydration station, a feed water from a feed water source;
removing, by a sediment filter comprising a plurality of filtration tubes filled with aluminum sulfate crystals, sediment and particulate matter from the feed water;
removing, by a carbon pre-filter, odors from the sediment free feed water;
filtering, by a reverse osmosis filtration unit connected to the carbon pre-filter, the odor free, sediment free water and generating a quantity of filtered water;
post filtering, by a carbon post filter connected to the reverse osmosis filtration unit, chlorine from the quantity of filtered water;
receiving, by a reverse osmosis tank connected to carbon post filter, the quantity of chlorine free filtered water;
pumping, by a booster pump operatively connected to the reverse osmosis tank, the quantity of chlorine free filtered water into a water reservoir located in an upper section of the smart hydration station;
sterilizing, by a plurality of ultraviolet lights, the quantity of chlorine free filtered water;
enriching, by a hydrogen infusion unit connected to a plurality of hydrogen intake ports in the water reservoir, the sterilized quantity of chlorine free filtered water with hydrogen gas;
receiving, by a microprocessor operatively connected to a touch screen display unit located on an exterior surface of a middle section of the smart hydration station, wherein the microprocessor has electrical circuitry, a memory storing program instructions, and at least one processor configured to execute the program instructions, an input signal based on a selection of a water temperature; and
instructing, by the microprocessor, a tri-temperature water station located in the middle section of the smart hydration station to dispense the hydrogen infused, sterilized, chlorine free, filtered water at the selected water temperature.

15. The method of claim 14, further comprising:
selecting, from the touch screen display unit, one of a plurality of selectable input buttons comprising an ON button, an OFF button, a hot water input button, a cold water input button and a selectable temperature input button;
receiving, by the microprocessor, the input signal based on the selected input button;
executing, by the at least one processor, the program instructions for:
connecting the microprocessor to a power source when the ON button is selected;
disconnecting the microprocessor from the power source when the OFF button is selected;
actuating, by the microprocessor, a heater surrounding a hot water dispensing pipe when the hot water input button is selected;
actuating, by the microprocessor, a refrigeration unit surrounding a cold water dispensing pipe when the cold water input button is selected; and
actuating, by the microprocessor, an electronically actuatable valve of a two way diverter connected to the hot water pipe to divert hot water from the hot water dispensing pipe to the hydrogen infused, sterilized, chlorine free, filtered water until a temperature sensor located downstream of the two way diverter records a temperature reading which matches the selectable temperature input.

16. The method of claim 15, further comprising:
displaying, on an LED display screen, a set of operational indicators of the smart hydration station which indicate an operational status comprising any one of:
the pumping, by the booster pump, the chlorine free filtered water into the water reservoir,
the sterilizing of the chlorine free filtered water by the plurality of ultraviolet lights,
the enriching, by the hydrogen infusion unit, of the sterilized, chlorine free filtered water,
the heating, by the heater, of the hydrogen enriched, sterilized, chlorine free filtered water,
the cooling, by the refrigeration unit, of the hydrogen enriched, sterilized, chlorine free filtered water,
the mixing, by the two way diverter, of the hydrogen enriched, sterilized, chlorine free filtered water to the selected temperature, and
a dispensing status, by the tri-temperature water station, of the hydrogen enriched, sterilized, chlorine free filtered water,
wherein the microprocessor is operatively connected to a power cord, the booster pump, plurality of ultraviolet lights, the hydrogen infusion unit, the heater, the refrigeration unit, an electronically actuatable valve of the two way diverter, the tri-temperature water station and the LED display screen, wherein the at least one processor is configured for executing the program instructions to display each operational indicator on the LED display screen.

17. The method of claim 14, further comprising:
generating, by a speaker operatively connected to the microprocessor, an alert when the hydrogen infused, sterilized, chlorine free filtered water at the selected temperature is ready for dispensing.

18. The method of claim 14, further comprising:
generating, by a speaker operatively connected to the microprocessor, a periodic reminder to drink the hydrogen infused, sterilized, chlorine free filtered water.

19. A method of dispensing hydrogen infused, sterilized, chlorine free filtered water from a smart hydration station, comprising:
pressing, on a touch screen display unit, an ON button;
choosing, from a plurality of selectable input buttons located on the touch screen display unit, one of a hot water input button, a cold water input button and a selectable temperature input button;
viewing, on an LED display screen, a set of operational indicators of the smart hydration station which indicate an operational status comprising any one of:
a receiving, through a feed water intake port located in a lower section of the smart hydration station, a feed water from a feed water source;
a removing, by a sediment filter comprising a plurality of filtration tubes filled with aluminum sulfate crystals, sediment and particulate matter from the feed water;
a removing, by a carbon pre-filter, odors from the sediment free feed water;
a filtering, by a reverse osmosis filtration unit connected to the carbon pre-filter, the odor free, sediment free water and generating a quantity of filtered water;
a post filtering, by a carbon post filter connected to the reverse osmosis filtration unit, chlorine from the quantity of filtered water;
a receiving, by a reverse osmosis tank connected to carbon post filter, the quantity of chlorine free filtered water;
a pumping, by a booster pump, the chlorine free filtered water from the reverse osmosis tank into a water reservoir,
a sterilizing of the chlorine free filtered water in the water reservoir by a plurality of ultraviolet lights,
an enriching, by a hydrogen infusion unit, of the sterilized, chlorine free filtered water,
a heating, by a heater, of the hydrogen enriched, sterilized, chlorine free filtered water when the hot water input button is pressed,
a cooling, by a refrigeration unit, of the hydrogen enriched, sterilized, chlorine free filtered water when the cold water input button is pressed,
a mixing, by a two way diverter, of the hydrogen enriched, sterilized, chlorine free filtered water to a selected temperature when the selectable temperature input button, and
a dispensing status, by the tri-temperature water station, of the hydrogen enriched, sterilized, chlorine free filtered water.

20. The method of claim 19, further comprising one or more of:
receiving, from a speaker operatively connected to the microprocessor, an alert when the hydrogen infused, sterilized, chlorine free filtered water at the selected temperature is ready for dispensing; and
dispensing, from the tri-temperature water station, the hydrogen enriched, sterilized, chlorine free filtered water at the selected temperature upon receiving, from a speaker operatively connected to the microprocessor, a reminder to drink the hydrogen infused, sterilized, chlorine free filtered water.
